(19) United States
(12) Patent Application Publication
(10) Pub. No.: US 2026/0162620 A1
(43) Pub. Date: Jun. 11, 2026

(54) GATE DRIVING CIRCUIT AND DISPLAY DEVICE INCLUDING THE SAME

(71) Applicant: LG Display Co., Ltd., Seoul (KR)

(72) Inventors: Yeon Woo SHIN, Paju-si (KR); Bo Kyoung KIM, Paju-si (KR); Sang Hee YU, Paju-si (KR); Moon Seok JUNG, Paju-si (KR)

(73) Assignee: LG Display Co., Ltd., Seoul (KR)

(21) Appl. No.: 19/373,055

(22) Filed: Oct. 29, 2025

(30) Foreign Application Priority Data
Dec. 6, 2024 (KR) 10-2024-0180118

(51) Int. Cl. G09G 3/3266; G09G 3/32

(52) U.S. Cl. CPC G09G 3/3266; G09G 3/32; G09G 2310/0267; G09G 2310/0286; G09G 2310/06; G09G 2330/021; G09G 2330/10

(57) ABSTRACT

Disclosed are a gate driving circuit and a display device including the same. The gate driving circuit includes a first circuit part that includes a Q1 node, a Q2 node, and a QB node and is configured to receive a G clock signal and a start signal or a carry signal and output a pulse of a first output signal via a first output node, and a second circuit part that includes a Q node, is connected to the QB node, and is configured to receive at least one B clock signal and output a pulse of a second output signal.

### CROSS-REFERENCE TO RELATED APPLICATION

This application claims priority to and the benefit of Korean Patent Application No. 10-2024-0180118, filed Dec. 6, 2024, the disclosure of which is incorporated herein by reference in its entirety.

### BACKGROUND

### Technical Field

The present disclosure relates to a gate driving circuit and a display device including the same.

### Description of Related Art

An electroluminescent display device includes self-emissive light-emitting elements, for example, organic light emitting diodes (OLEDs), which are arranged in respective sub-pixels, and has advantages of fast response speed, high luminous efficiency, high luminance, and a wide viewing angle. The electroluminescent display device not only has a fast response speed and excellent luminous efficiency, luminance, and viewing angle, but also can represent black gradation as complete black, and thus has excellent contrast ratio and color reproduction rate. Such an electroluminescent display device does not require a backlight unit and may be implemented on a plastic substrate, a thin glass substrate, and a metal substrate that are flexible materials.

An electroluminescence display includes a data driving circuit that supplies a data signal to data lines of a display panel in which pixels are provided, and a gate driving circuit that supplies a gate signal to gate lines of the display panel.

The gate driving circuit includes a plurality of transistors. The transistors of the gate driving circuit may be implemented by p-channel transistors, n-channel transistors, or a complementary metal-oxide semiconductor (CMOS) circuit in which p-channel transistors and n-channel transistors are combined. A p-channel transistor-based gate driving circuit outputs a gate signal not suitable for driving an n-channel transistor-based pixel circuit. A CMOS circuit is susceptible to positive bias temperature stress (PBTS) since a gate voltage of the n-channel transistor is in a normally high state, and the deterioration of the n-channel transistor affects a pulse of a gate signal output from the gate driving circuit, causing waveform distortion of the gate signal. As a result, a charging rate of the pixel may be reduced, and the image quality of the display device may be reduced. In the case of the n-channel transistor-based gate driving circuit, since a channel width of the n-channel transistor is large, the complexity of a manufacturing process is increased when the gate driving circuit is formed on the display panel.

### BRIEF SUMMARY

The present disclosure provides a gate driving circuit that is suitable for an n-channel transistor-based pixel circuit, which improves reliability and a design of a narrow bezel, and a display device including the same.

The technical featured of the embodiments of the present disclosure are not limited to those described herein, and other features or characteristics not described will be clearly understood by those skilled in the art from the following description.

A gate driving circuit according to one embodiment includes: a first circuit part that includes a Q1 node, a Q2 node, and a QB node and is configured to receive a G clock signal and a start signal or a carry signal and output a pulse of a first output signal via a first output node; and a second circuit part that includes a Q node, is connected to the QB node, and is configured to receive at least one B clock signal and output a pulse of a second output signal. The G clock signal includes a pulse of a first gate voltage, and the B clock signal includes a pulse of a second gate voltage lower than the first gate voltage.

The second circuit part may include: a first transistor including a gate electrode connected to the Q node, a first electrode connected to a first B clock node, and a second electrode; a second transistor including a gate electrode connected to a VGL node to which the second gate voltage is applied, a first electrode connected to the Q2 node, and a second electrode connected to the Q node; a capacitor connected between the Q node and the second electrode of the first transistor; a third transistor that is turned on in response to a voltage of the Q node and transmits a voltage of a first B clock signal that is input to a second B clock node, to a second output node from which the pulse of the second output signal is output; and a fourth transistor that is turned on in response to a voltage of the QB node and electrically connects the second output node to the VGL node to which the second gate voltage is applied.

A pulse of a fourth B clock signal that is input to the first B clock node may be generated earlier than a pulse of the first B clock signal that is input to the second B clock node.

The first circuit part may include a plurality of p-channel transistors. Each of the first transistor, the second transistor, the third transistor, and the fourth transistor of the second circuit part may be a p-channel transistor.

The second circuit part may output the pulse of the second output signal via the second output node in synchronization with a pulse of the first B clock signal and then output a pulse of a third output signal via a third output node in synchronization with a pulse of a second B clock signal. The second circuit part may further include: a fifth transistor that is turned on in response to the voltage of the Q node and transmits a voltage of the second B clock signal that is input to a third B clock node, to the third output node; and a sixth transistor that is turned on in response to the voltage of the QB node and electrically connects the third output node to the VGL node. Each of the fifth transistor and the sixth transistor of the second circuit part may be a p-channel transistor.

The first circuit part may include a shift register including the plurality of p-channel transistors or an edge trigger including the plurality of p-channel transistors.

The first circuit part may include: a first transistor including a gate electrode connected to a first G clock node, a first electrode connected to a VST node to which a start signal or a carry signal is input, and a second electrode connected to the Q2 node; a second transistor including a gate electrode connected to the QB node, a first electrode connected to the Q2 node, and a second electrode connected to a VGH node to which the first gate voltage is applied; a third transistor including a gate electrode connected to a second G clock node, a first electrode connected to the VGL node, and a second electrode connected to the QB node; a fourth transistor including a gate electrode connected to the VST node, a first electrode connected to the QB node, and a second electrode connected to the VGH node; a fifth transistor including a gate electrode connected to the VGL node, a first electrode connected to the Q1 node, and a second electrode connected to the Q2 node; a sixth transistor including a gate electrode connected to the Q1 node, a first electrode connected to a third G clock node, and a second electrode connected to the first output node from which the pulse of the first output signal is output; a seventh transistor including a gate electrode connected to the QB node, a first electrode connected to the first output node, and a second electrode connected to the VGH node; and an eighth transistor including a gate electrode connected to the Q2 node, a first electrode connected to the QB node, and a second electrode connected to the VGH node.

A B clock signal that is input to the first B clock node may be a signal with a phase opposite to a G clock signal that is input to the first G clock node.

The voltage of the Q node may have the same phase as voltages of the Q1 node and the Q2 node. The voltage of the QB node may have a phase opposite to the voltages of the Q node, the Q1 node, and the Q2 node.

The second circuit part may output the pulse of the second output signal via the second output node in synchronization with a pulse of the first B clock signal and then output a pulse of a third output signal via a third output node in synchronization with a pulse of a second B clock signal. The second circuit part further may include: a fifth transistor that is turned on in response to the voltage of the Q node and transmits a voltage of the second B clock signal that is input to a third B clock node, to the third output node; and a sixth transistor that is turned on in response to the voltage of the QB node and electrically connects the third output node to the VGL node. Each of the fifth transistor and the sixth transistor of the second circuit part is a p-channel transistor. A B clock signal that is input to the first B clock node may be a signal with a phase opposite to a G clock signal that is input to the first G clock node. A B clock signal that is input to the third B clock node may be a signal with a phase opposite to a G clock signal that is input to the second G clock node.

The first circuit part may include: a first transistor including a gate electrode connected to a first G clock node, a first electrode connected to a VST node, and a second electrode connected to the Q2 node; a second transistor including a gate electrode connected to the VST node, a first electrode connected to the first G clock node via a second capacitor, and a second electrode connected to a VGH node to which the first gate voltage is applied; a third transistor including a gate electrode coupled to the first G clock node via the second capacitor, a first electrode connected to the first G clock node, and a second electrode connected to the QB node; a fourth transistor including a gate electrode connected to the Q2 node, a first electrode connected to the QB node, and a second electrode connected to the VGH node; a fifth transistor including a gate electrode connected to the VGL node, a first electrode connected to the Q1 node, and a second electrode connected to the Q2 node; a sixth transistor including a gate electrode connected to the Q1 node, a first electrode connected to the VGL node, and a second electrode connected to a first output node from which the pulse of the first output signal is output; and a seventh transistor including a gate electrode connected to the QB node, a first electrode connected to the first output node, and a second electrode connected to the VGH node.

A pulse interval of a G clock signal that is input to the first G clock node may be greater than a pulse interval of a B clock signal that is input to each of the first and second clock nodes.

A pulse interval of the first output signal may be greater than a pulse interval of the second output signal.

A display device according to one embodiment includes a display panel in which a plurality of data lines, a plurality of gate lines, a plurality of pixels, and a gate driving circuit configured to output a gate signal to the gate lines are provided. Each of the pixels includes a plurality of n-channel transistors that are switched in response to the gate signal.

According to the embodiments of the present disclosure, it is possible to improve the power consumption of the display device, and to reduce the deterioration of the gate driving circuit by reducing accumulation of stress of the transistors in the gate driving circuit. As a result, according to the embodiments of the present disclosure, it is possible to improve the rising and falling characteristics of the pulse output from the gate driving circuit, to improve the reliability and lifetime of the gate driving circuit, and to improve the image quality of the display device.

According to the embodiments of the present disclosure, when the gate driving circuit is implemented based on an n-channel transistor, it is possible to prevent reduction in reliability due to the PBTS of the n-channel transistor.

According to the embodiments of the present disclosure, it is possible to implement a narrow bezel by separating the clock input to the output buffer of the gate driving circuit from the Q node and outputting the pulse of the gate signal as multiple pulses using a multi-stage buffer in a p-channel transistor-based circuit.

The effects of the present disclosure are not limited to the effects described above, and other effects not described will be understood by those skilled in the art from the following description and the appended claims.

### BRIEF DESCRIPTION OF THE SEVERAL VIEWS OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to an embodiment of the present disclosure;

FIGS. 2 and 3 are circuit diagrams illustrating an example of a display area according to the embodiment of the present disclosure;

FIGS. 4 and 5 are circuit diagrams illustrating a gate driving circuit according to the embodiment of the present disclosure;

FIG. 6 is a circuit diagram illustrating an example of a shift register circuit that can be applied to a first circuit part of the gate driving circuit illustrated in FIGS. 4 and 5;

FIG. 7 is a diagram schematically illustrating a configuration of a gate driver to which the gate driving circuit illustrated in FIG. 6 can be applied;

FIG. 8 is a waveform chart illustrating input and output signals of the gate driver illustrated in FIG. 7 and voltages of main nodes;

FIGS. 9 to 18 are diagrams illustrating an operation of the gate driving circuit illustrated in FIG. 6 in stages;

FIG. 19 is a diagram illustrating a simulation result of the gate driving circuit illustrated in FIG. 6;

FIG. 20 is a circuit diagram illustrating an example of an edge trigger circuit that can be applied to the first circuit part of the gate driving circuit illustrated in FIGS. 4 and 5;

FIG. 21 is a diagram schematically illustrating a configuration of a gate drier to which the gate driving circuit illustrated in FIG. 20 can be applied;

FIG. 22 is a waveform chart illustrating input and output signals of the gate driver illustrated in FIG. 21 and voltages of main nodes;

FIGS. 22 to 32 are diagrams illustrating an operation of the gate driving circuit illustrated in FIG. 20 in stages; and

FIG. 33 is a diagram illustrating a simulation result of the gate driving circuit illustrated in FIG. 20.

### DETAILED DESCRIPTION

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” “having,” and “consist of” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after”, “following”, “next to”, “before”, or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

The pixel circuit and the gate drive circuit of the display device may include a plurality of transistors. The transistor may be implemented as a thin film transistor (TFT). The transistors may be implemented as an oxide thin film transistor (Oxide TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor, since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage VGH, and the gate-off voltage may be a gate low voltage VGL. In the case of a p-channel transistor, the gate-on voltage may be the gate low voltage VGL, and the gate-off voltage may be the gate high voltage VGH.

Hereinafter, various embodiments of the present disclosure will be described in detail with reference to the accompanying drawings.

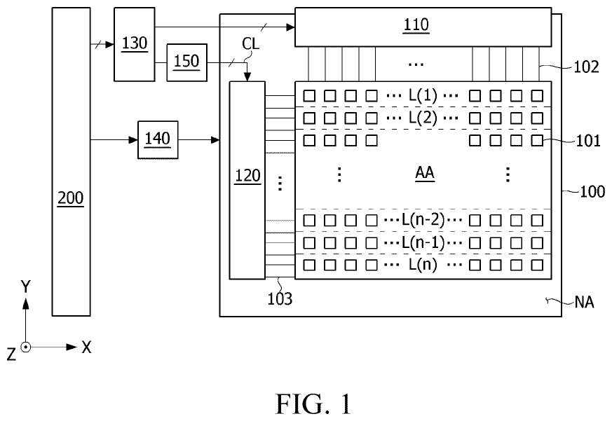

FIG. 1 is a block diagram illustrating a display device according to an embodiment of the present disclosure.

Referring to FIG. 1, the display device according to one embodiment of the present disclosure includes a display panel 100, display panel driving circuits, such as a data driver 110 and a gate driver 120, for writing image data to pixels 101 of the display panel 100, and a power circuit 140 for generating power necessary for driving the pixels 101 and the display panel driving circuits.

The display panel 100 may be, but is not limited to, a rectangular shaped panel having a width in the X-axis direction (first direction), a length in the Y-axis direction (second direction), and a thickness in the Z-axis direction (third direction). For example, at least a portion of the display panel 100 may have a curved outer periphery. The display panel 100 may be implemented as a non-transmissive display panel or a transmissive display panel. The transmissive display panel may be applied to a transparent display device in which an image is displayed on a screen and an actual object in the background is visible. The display panel 100 may be implemented as a flexible display panel.

The display panel 100 may include a display area AA and a non-display area NA outside the display area AA. The display area AA of the display panel 100 may include a pixel array for displaying images thereon. The pixel array may include a plurality of data lines 102, a plurality of gate lines 103 intersecting the data lines 102, and the pixels 101 arranged in a matrix form. The display panel 100 may further include a plurality of power lines commonly connected to the pixel circuits of the pixels 101. Each of the power lines contains a constant voltage node connected to the respective pixel circuit.

The pixels 101 may include two or more sub-pixels for color implementation. For example, each of the pixels 101 may be divided into a red sub-pixel, a green sub-pixel, and a blue sub-pixel. Each of the pixels 101 may further include a white sub-pixel. Each of the sub-pixel includes a pixel circuit for driving a light-emitting element. Each of the sub-pixels of the pixels 101 may be connected to the data line 102, the gate line 103, and the power line.

In the display area AA, the pixel array may include a plurality of pixel lines L(1) to L(n). Each of the pixel lines L(1) to L(n) may include one line of the pixels 101 arranged along the X-axis direction in the pixel array of the display panel 100. The pixels 101 arranged in one pixel line may share the gate lines 103. The pixels arranged along the Y-axis direction may share a data line 102. One horizontal period is a time obtained by dividing one frame period by the total number of pixel lines L(1) to L(n).

The driving circuits, such as the data driver 110 and the gate driver 120, of the display panel 100 write pixel data of the input image to the pixels under the control of the timing controller 130.

The timing controller 130 may receive the pixel data of the input image, and a timing signal synchronized with the pixel data from the host system 200. The timing signal may include a vertical synchronization signal Vsync, a horizontal synchronization signal Hsync, a main clock CLK, and a data enable signal DE. One cycle of the vertical synchronization signal Vsync may be a period of one frame. One cycle of the horizontal synchronization signal Hsync and the data enable signal DE may be one horizontal period 1H. The pulse of the data enable signal DE may be synchronized with one line of data to be written to the pixels 101 on one pixel line. Since a frame period and a horizontal period may be known by counting the data enable signal DE, the vertical synchronization signal Vsync and the horizontal synchronization signal Hsync may be omitted. The timing controller 130 may transmit the pixel data of the input image to the data driver 110 and control the operation timing of the data driver 110 and the gate driver 120. A gate timing control signal generated from the timing controller 130 may be input to the gate driver 120 through a level shifter 150.

The level shifter 150 may receive the gate timing control signal to output a start pulse and a clock. An input signal to the level shifter 150 may be a signal of a digital signal voltage level, and an output signal from the level shifter 150 may include pulses of an analog voltage that swings between a gate high voltage VGH and a gate low voltage VGL. The level shifter 150 may convert a low level voltage of the gate timing signal output from the timing controller 130 to the gate low voltage (VGL) and a high level voltage to the gate high voltage (VGH). The level shifter 150 and the gate driver 120 may be electrically connected via a clock line CL over which the start pulse and the clock signal are transmitted.

The data driver 110 may receive the pixel data of the input image received as a digital signal from the timing controller 130 and output a data voltage. The data driver 110 may convert the pixel data of the input image into a gamma compensated voltage using a digital-to-analog converter, hereinafter referred to as “DAC”, and output the data voltage. A gamma reference voltage output from the power circuit 140 may be divided into the gamma compensated voltage for each grayscale by a voltage divider circuit in the data driver 110 and supplied to the DAC. The DAC may generate the data voltage as the gamma compensated voltage corresponding to the grayscale value of the pixel data. The data voltage output from the DAC may be output to the data lines 102 through the output buffer in the respective channels of the data driver 110. The data voltage output from the data driver 110 may vary depending on the grayscale value of the pixel data. The data voltage may be determined according to the pixel data within a dynamic range between a maximum voltage and a minimum voltage that are determined based on the gamma reference voltage.

The circuit of the data driver 110 may be integrated into a drive IC (Integrated Circuit). The drive IC may be bonded to the display panel 100 using a chip on glass (COG) process, or it may be implemented as a chip on film (COF) and bonded to the display panel 100 and electrically connected to the data line 102.

The gate driver 120 may be disposed on the display panel 100. The gate driver 120 may be disposed in the non-display area NA outside the display area AA in the display panel 100, or it may be partially disposed in the display area AA. The gate driver 120 may supply a gate signal to the gate lines 103 in a single feeding method. In the single feeding method, the gate signal may be applied at one ends of the gate lines 103. In a double feeding method, the gate signal may be applied simultaneously at both ends of the gate lines 103. The gate signal output from the gate driver 120 may be applied to the pixels 101.

A plurality of gate signals may be applied to the pixel circuits of the pixels 101. In this case, a plurality of gate lines 103 are connected to the pixel circuits so that the gate signals of different waveforms can be applied. The gate driver 120 may include a plurality of gate drivers that output different gate signals. Each of the gate drivers may include circuits such as shift registers, edge triggers, and the like to shift the pulses of the gate signals.

The power circuit 140 may include, but is not limited to, a charge pump, a regulator, a buck converter, a boost converter, and the like. The power circuit 140 may receive a direct current input voltage from the host system 200 to generate the power required to drive the driving circuits 110 and 120 of the display panel 100 and the pixels 101 of the display panel 100. The power circuit 140 may output a constant voltage (or DC voltage), such as the gamma reference voltage, the gate high voltage, the gate low voltage, etc. In addition, the power circuit 140 may output a constant voltage to be provided to the pixels 101. The gamma reference voltage may be supplied to the data driver 110. The gate high voltage VGH and the gate low voltage VGL may be supplied to the level shifter 150 and the gate driver 120. The constant voltages input to the pixel circuit, such as pixel driving voltage EVDD, pixel ground voltage EVSS, and the like may be applied to the pixels 101 through the power lines commonly connected to the pixels 101. The pixel ground voltage EVSS may be the cathode voltage. The power circuit 140 may be implemented as a power IC such as a power management integrated circuit (PMIC), an electronics integrated circuit (ELIC), or the like, but is not limited thereto.

The driving circuits, such as a data driver 110 and a gate driver 120, of the display panel 100 may be driven at a variable refresh rate (VRR) under the control of the timing controller 130. For example, the timing controller 130 may reduce power consumption of the display device by analyzing the input image and lowering the refresh rate when the input image does not change by a preset amount of time. In this case, the driving circuit of the display panel 100 (such as a data driver 110 and a gate driver 120) may lower the refresh rate of the pixels P when a still image is input for a certain period of time or more under the control of the timing controller 130 to control a data writing period of the pixels P to be longer, thereby reducing the power consumption of the display device. The driving circuit of the display panel 100 (such as a data driver 110 and a gate driver 120) may reduce the refresh rate when the display device is operated in standby mode or in response to a user command. Further, the refresh rate may be lowered in an always on display (AOD) screen. The AOD screen may be a small area of pixels in the display area AA in which preset information, for example, brief information such as remaining battery power, time, and the like are displayed in the standby mode.

The host system 200 may scale an image signal from a video source to match the resolution of the display panel 100, and may transmit it to the timing controller 130 together with the timing control signal.

Due to process deviations and device characteristic deviations occurring during the manufacturing process of the display panel 100, there may be differences in electrical characteristics of the driving elements across pixels, and such differences may increase as driving time of the pixels 101 elapses. To compensate for the deviations in the electrical characteristics of the driving elements across the pixels, an internal compensation circuit may be incorporated into the pixel circuit or the pixel circuit may be connected to an external compensation circuit. The internal compensation circuit is incorporated into the pixel circuit to sense the threshold voltage variation of the driving element and compensates the gate-source voltage of the driving element by the threshold voltage variation. The external compensation circuit may compensate for variation in the electrical characteristics of the driving element based on a compensation value selected based on the results of sensing the electrical characteristics of the driving element using the external compensation circuit connected to the pixel circuit.

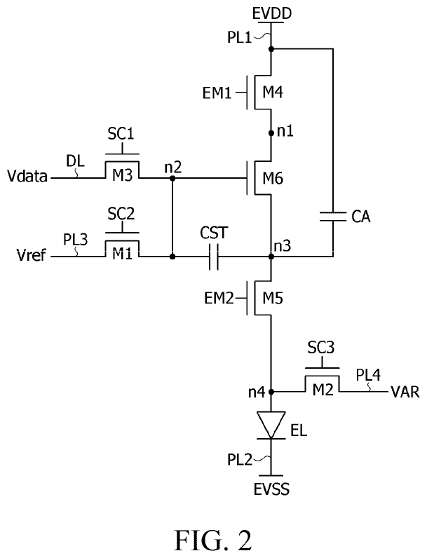

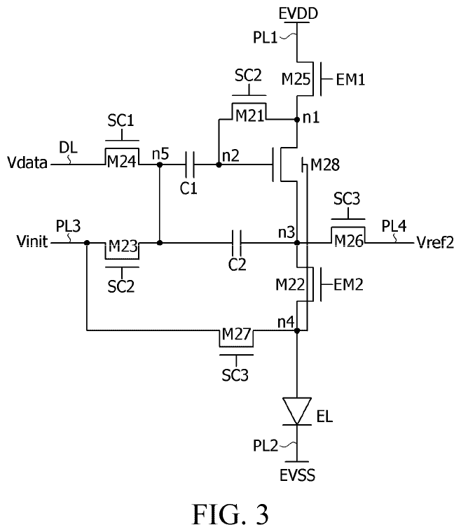

The pixel circuit may be implemented based on an n-channel oxide TFT as shown in FIGS. 2 and 3 in order to reduce power consumption. FIGS. 2 and 3 show one example of pixel circuits, including an internal compensation circuit based on an n-channel oxide TFT. It should be noted that the pixel circuits of the present disclosure is not limited to FIGS. 2 and 3. In FIGS. 2 and 3, PL1 to PL4 may be constant voltage nodes.

FIG. 2 is a circuit diagram illustrating a pixel circuit of a display area according to the embodiment of the present disclosure.

Referring to FIG. 2, the pixel circuit includes a driving element M6 for driving a light-emitting element EL, a plurality of switch elements M1 to M5, a first capacitor CST, and a second capacitor CA. The driving element M6 and the switch elements M1 to M5 may be implemented by n-channel Oxide TFTs, but the embodiments of the present disclosure are not limited thereto.

The light-emitting element EL may be implemented as an OLED or an inorganic LED such as a micro LED. The light-emitting element EL may include a capacitor present between an anode electrode and a cathode electrode. The OLED includes an anode electrode, a cathode electrode, and an organic compound layer interposed between these electrodes. The organic compound layer may include a hole injection layer (HIL), a hole transport layer (HTL), a light emission layer (EML), an electron transport layer (ETL), and an electron injection layer (EIL), but is not limited thereto. When a voltage is applied to the anode electrode and the cathode electrode of the light-emitting element EL, holes passing through the hole transport layer (HTL) and electrons passing through the electron transport layer (ETL) move into the light emission layer (EML) to form excitons. At this time, visible light is emitted from the light emission layer (EML). The OLED may be implemented as an OLED having a tandem structure in which a plurality of light emission layers are stacked. The OLED having the tandem structure may improve the luminance and lifetime of a pixel.

The anode electrode of the light-emitting element EL may be connected to a fourth node n4, and the cathode electrode of the light-emitting element EL may be connected to a second constant voltage node PL2 to which the pixel ground voltage EVSS is applied. The light-emitting element EL includes a capacitor formed between the anode electrode and the cathode electrode.

The driving element M6 generates a current according to a gate-source voltage Vgs and drives the light-emitting element EL. The gate-source voltage Vgs of the driving element M6 may be a voltage that is applied between a second node n2 and a third node n3. The driving element M6 includes a first electrode connected to a first node n1, a gate electrode connected to the second node n2, and a second electrode connected to the third node n3. The first capacitor CST is connected between the second node n2 and the third node n3. The second capacitor CA may be connected between a first constant voltage node PL1 and the third node n3.

Each of the switch elements M1 to M5 is turned on in response to a gate on voltage of a gate signal SC1, SC2, SC3, or EM applied to the gate electrode thereof and is turned off in response to a gate off voltage of the gate signal. In an n-channel transistor, the gate on voltage may be a gate high voltage (or a first gate voltage), and the gate off voltage may be a gate low voltage (or a second gate voltage) lower than the gate high voltage. The gate signals may include a first scan signal SC1, a second scan signal SC2, a third scan signal SC3, and a light emission signal (hereinafter, referred to as an “EM signal”). In this case, the gate driver 120 may include a first gate driver that outputs the first scan signal SC1, a second gate driver that outputs the second scan signal SC2, a third gate driver that outputs the third scan signal SC3, and a fourth gate driver that outputs the EM signal EM. Each of the first to fourth gate drivers may start to output a pulse of the gate signal in response to a start pulse and may shift the pulse in conformity with a shift clock timing.

A first switch element M1 is connected between a third constant voltage node PL3 to which a reference voltage Vref is applied and the second node n2, and is turned in response to the gate on voltage of the second scan signal SC2. When the first switch element M1 is turned on, the reference voltage Vref is applied to the second node n2. A second switch element M2 is connected between a fourth constant voltage node PL4 to which an anode reset voltage VAR is applied and the fourth node n4, and is turned on in response to the gate on voltage of the third scan signal SC3. When the second switch element M2 is turned on, the anode reset voltage VAR is applied to the fourth node n4. A third switch element M3 is connected between a data line DL to which a data voltage Vdata of pixel data is applied and the second node n2, and is turned on in response to the gate on voltage of the first scan signal SC1. When the third switch element M3 is turned on, the data voltage Vdata is applied to the second node n2. A fourth switch element M4 is connected between the first constant voltage node PL1 to which the pixel driving voltage EVDD is applied and the first node n1, and is turned on in response to a gate on voltage of a first EM signal EM1. When the fourth switch element M4 is turned on, the pixel driving voltage EVDD may be applied to the first node n1. A fifth switch element M5 is connected between the third node n3 and the fourth node n4, and is turned on in response to a gate on voltage of a second EM signal EM2. When the fifth switch element M5 is turned on, the third node n3 may be electrically connected to the fourth node n4.

FIG. 3 is a circuit diagram illustrating a pixel circuit of the display area according to another embodiment of the present disclosure. In this embodiment, redundant description to the pixel circuit illustrated in FIG. 2 will not be repeated.

Referring to FIG. 3, the pixel circuit includes a driving element M28, a plurality of switch elements M21 to M27, a first capacitor C1, and a second capacitor C2. The driving element M28 and the switch elements M21 to M27 may be implemented by n-channel Oxide TFTs, but the embodiments of the present disclosure are not limited thereto.

The anode electrode of the light-emitting element EL may be connected to a fourth node n4, and the cathode electrode of the light-emitting element EL may be connected to a second constant voltage node PL2 to which the pixel ground voltage EVSS is applied. The first capacitor C1 is connected between a second node n2 and a fifth node n5. The second capacitor C2 is connected between a third node n3 and the fifth node n5.

The driving element M28 may be a transistor having a double-gate structure. The driving element M28 includes a first gate electrode connected to the second node n2, a second gate electrode connected to the fourth node n4, a first electrode connected to a first node n1, and a second electrode connected to the third node n3.

Each of the switch elements M21 to M27 is turned on in response to a gate on voltage of a gate signal applied to a gate electrode thereof and is turned off in response to a gate off voltage of the gate signal. A first switch element M21 may be turned on in response to a gate on voltage of a second scan signal SC2 and may electrically connect the first node n1 to the second node n2. A second switch element M22 may be turned on in response to a gate on voltage of a second EM signal EM2 and may form a current path between the driving element M28 and the light-emitting element EL. A third switch element M23 may be turned on in response to the gate on voltage of the second scan signal SC2 and may supply an initialization voltage Vinit to the fifth node n5. A fourth switch element M24 may be turned on in response to a gate on voltage of a first scan signal SC1 and may supply a data voltage Vdata to the fifth node n5. A fifth switch element M25 may be turned on in response to a gate on voltage of a first EM signal EM1 and may supply the pixel driving voltage EVDD to a first node n1. A sixth switch element M26 may be turned on in response to a gate on voltage of a third scan signal SC3 and may supply a reference voltage Vref2 to the third node n3. A seventh switch element M27 may be turned on in response to the gate on voltage of the third scan signal SC3 and may supply the initialization voltage Vinit to the fourth node n4.

A gate driving circuit that will be described in the following embodiment may output gate signals that are applied to gate electrodes of n-channel transistors used as switch elements of a pixel circuit as in FIGS. 2 and 3.

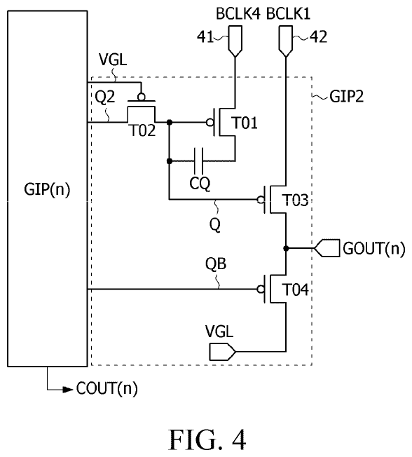

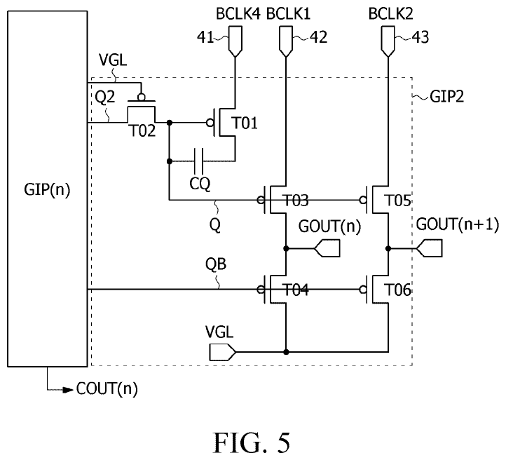

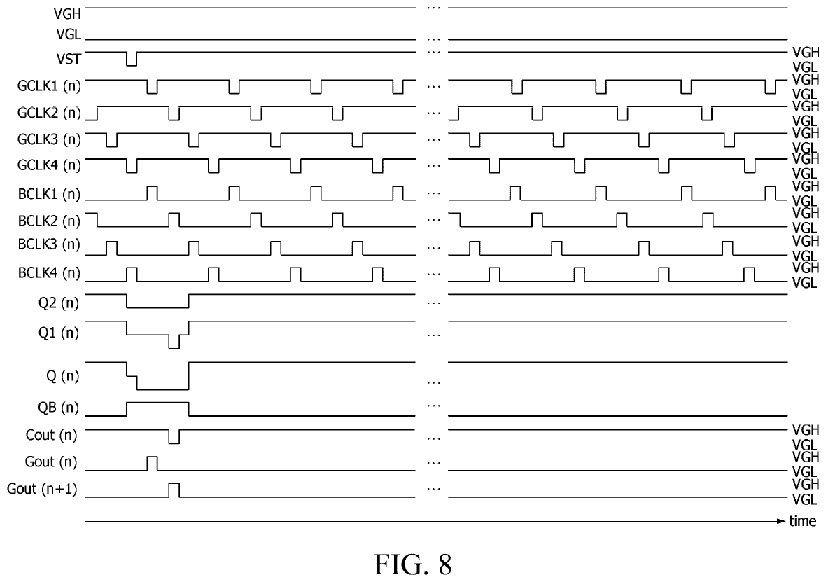

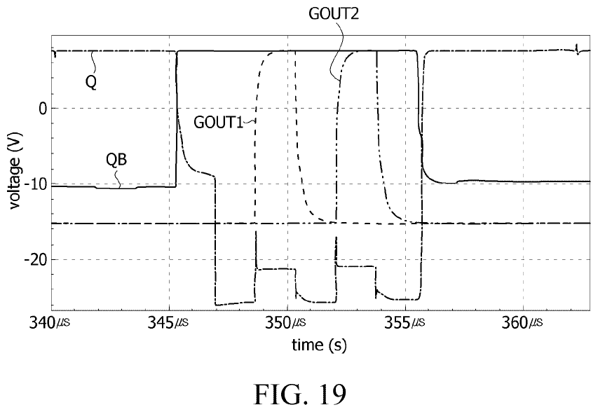

FIGS. 4 and 5 are circuit diagrams illustrating a gate driving circuit according to the embodiment of the present disclosure. The gate driving circuit illustrated in FIGS. 4 and 5 may be an n-th (where n is a positive integer) signal transmitter as illustrated in FIGS. 8 and 19. Hereinafter, a gate high voltage VGH may be interpreted as a first gate voltage, and a gate low voltage VGL may be interpreted as a second gate voltage.

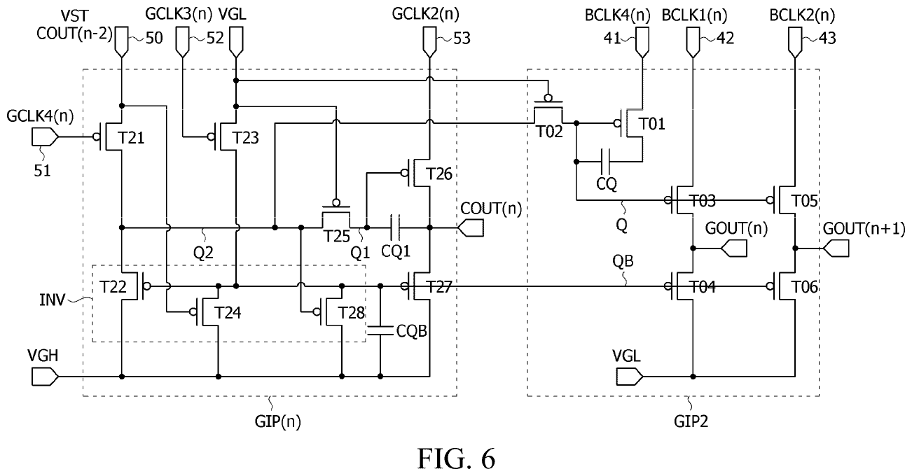

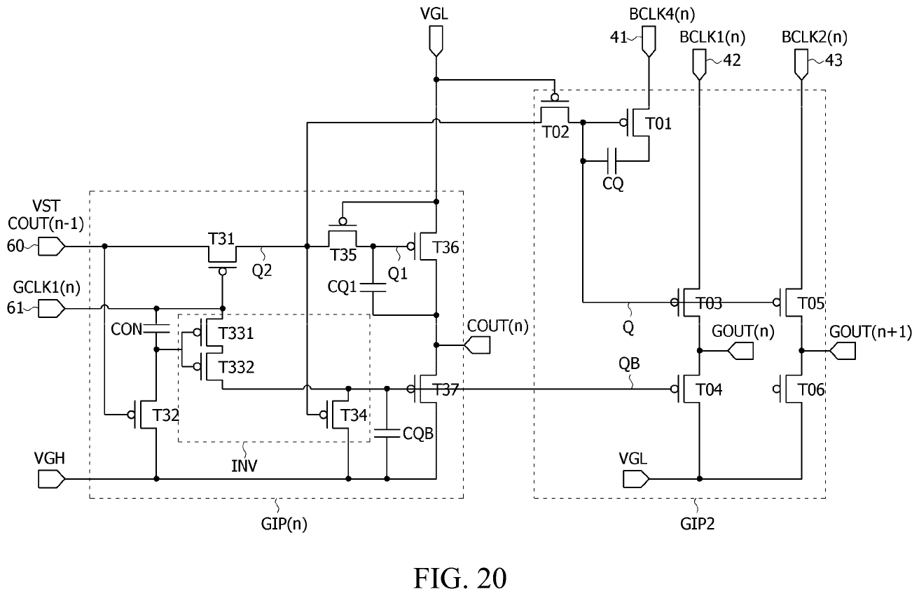

Referring to FIGS. 4 and 5, the gate driving circuit includes a first circuit part GIP(n) and a second circuit part GIP2 that share at least one control node. Control nodes of the gate driving circuit charge and discharge output nodes and control waveforms of output signals COUT(n) and GOUT(n). As illustrated in FIGS. 6 and 20, the control nodes of the gate driving circuit include a Q1 node, a Q2 node, a QB node, and a Q node. The first circuit part GIP(n) and the second circuit part GIP2 may share at least the Q2 node and the QB node.

The gate driving circuit outputs the pulses of the n-th output signals COUT(n) and GOUT(n). The n-th output signals COUT(n) and GOUT(n) include a first output signal COUT(n) and a second output signal GOUT(n). The first output signal COUT(n) is input as a carry signal to a VST node of a next signal transmitter, for example, an (n+1)th signal transmitter or an (n+2)th signal transmitter such that the pulse of the gate signal can be shifted. The second output signal GOUT(n) is a gate signal that is applied to the pixel circuit via a corresponding gate line. For example, the pulse of the second output signal GOUT(n) may be the pulse of the gate signal (SC1, SC2, SC3, or EM (such as EM1 and EM2)) illustrated in FIGS. 2 and 3.

The first circuit part GIP(n) charges and discharges the control nodes according to input signals and outputs the first output signal COUT(n). The signals input to the first circuit part GIP(n) may include a clock signal, a start pulse, a first output signal from a previous signal transmitter, and the like. The previous signal transmitter may be a first circuit part of an (n−1)th signal transmitter or an (n−2)th signal transmitter that generates the pulse of the output signal earlier than the n-th output signals COUT(n) and GOUT(n).

The first circuit part GIP(n) may be implemented as a p-channel transistor-based circuit. As illustrated in FIGS. 6 and 20, the control nodes of the first circuit part GIP(n) include the Q1 node, the Q2 node, and the QB node. When the voltage of the Q1 node is the gate low voltage VGL, the pulse of the first output signal COUT(n) may be output via a first output node. A pulse interval voltage of the first output signal COUT(n) may be the gate low voltage VGL. When the voltage of the QB node is the gate low voltage VGL, the voltage of the first output node is changed to the gate high voltage.

The second circuit part GIP2 may include a plurality of transistors T01 to T04. Each of the transistors T01 to T04 may be implemented by a p-channel transistor. The second circuit part GIP2 include the Q node that can be electrically connected to the Q2 node via a second transistor T02, and the second circuit part GIP2 is connected to the QB node of the first circuit part GIP(n). The second circuit part GIP2 may output the gate signal to be applied to the pixel circuit as the pulse of the second output signal GOUT(n) in response to the voltages of the Q2 node and the QB node. The transistors constituting the first circuit part GIP(n) can correspond to the first-(N)th transistors, respectively. The transistors constituting the second circuit part GIP2 can correspond to the second-(N)th transistors, respectively.

A first transistor T01 includes a gate electrode connected to the Q node, a first electrode connected to a first B clock node 41 to which a fourth B clock signal BCLK4(n) is input, and a second electrode connected to the Q node by capacitor coupling. A capacitor CQ is connected between the Q node and the second electrode of the first transistor T01.

In a state in which the Q node is pre-charged with the gate low voltage VGL, the Q node is coupled to a second output node via the capacitor CQ and the first transistor T01 is turned on. In this state, when the pulse of the fourth B clock signal BCLK4(n) is input to the first transistor T01, bootstrapping may occur. When the Q node is bootstrapped, the voltage of the Q node is boosted to a voltage lower than the gate low voltage VGL. As a result, the gate-source voltage of the first transistor T01 becomes large, and the pulse of the second output signal GOUT(n) rises fast to the gate high voltage. A pulse interval voltage of the second output signal GOUT(n) is the gate high voltage. The pulse interval voltage of the second output signal GOUT(n) may be the gate on voltage that turns on the switch element of the pixel circuit.

A B clock set of clock signals BCLK1(n) and BCLK4(n) that is input to the second circuit part GIP2 may be generated with a phase opposite to the clock signal that is input to the first circuit part GIP(n). A pulse interval voltage of the B clock set of clock signals BCLK1(n) and BCLK4(n) is the gate high voltage. As illustrated in FIG. 8, the pulse of the fourth B clock signal BCLK4(n) is generated earlier than a pulse of a first B clock signal BCLK1(n) and bootstraps the Q node before the pulse of the second output signal GOUT(n) is output.

The pulse interval voltage of the second output signal GOUT(n) is the gate high voltage. The pulse interval voltage of the second output signal GOUT(n) may be the gate on voltage that turns on the switch element of the pixel circuit.

A second transistor T02 is a switch element that electrically separates the Q node and the Q2 node such that, when the voltage of the Q node is bootstrapped, the voltage of the Q2 node is not bootstrapped in conjunction with the voltage of the Q node. The second transistor T02 includes a gate electrode to which the gate low voltage VGL is applied, a first electrode connected to the Q2 node, and a second electrode connected to the Q node. When the voltage of the Q node is changed from the gate high voltage to a voltage lower than the gate low voltage VGL due to bootstrapping, the second transistor T02 may be turned off. When the voltage of the Q2 node is the gate high voltage, the second transistor T02 may be turned on. When the second transistor T02 is turned on, the first transistor T01 may be turned off.

A third transistor T03 and a fourth transistor T04 configure an output buffer BUF1 that outputs the pulse of the second output signal GOUT(n) in response to the voltages of the Q node and the QB node. The third transistor T03 may be turned on in response to a voltage equal to or lower than the gate low voltage VGL charged in the Q node. The fourth transistor T04 may be turned on in response to the gate low voltage VGL charged in the QB node.

In a state in which the Q node is boosted to a voltage lower than the gate low voltage VGL due to bootstrapping, the third transistor T03 transmits a pulse interval voltage of the first B clock signal BCLK1(n) to an output node to increase the voltage of the second output signal GOUT(n) to the gate high voltage. The third transistor T03 includes a gate electrode connected to the Q node, a first electrode connected to a second B clock node 42 to which the first B clock signal BCLK1(n) is input, and a second electrode connected to the second output node.

When the voltage of the QB node is the gate low voltage VGL, the fourth transistor T04 is turned on and connects the second output node to a VGL node to which the gate low voltage VGL is applied, to decrease the voltage of the second output signal GOUT(n) to the gate low voltage VGL. The fourth transistor T04 includes a gate electrode connected to the QB node, a first electrode connected to the second output node, and a second electrode connected to the VGL node.

When the Q node is bootstrapped and the voltage of the Q node is pre-charged with a voltage lower than the gate low voltage VGL, the gate-source voltage of the third transistor T03 increases. For this reason, when the pulse of the second output signal GOUT(n) is output, the current driving ability of the third transistor T03 is improved. As a result, a channel width W of the third transistor T03 can become small to make the size of the third transistor T03 become small, an RC load of a clock line in which the B clock signals BCLK1(n) and BCLK4(n) are transmitted can be reduced, and an RC delay of the B clock signals BCLK1(n) and BCLK4(n) and the second output signal GOUT(n) can be reduced. In addition, improvement of the rising and falling characteristics of the pulse such as reduction in slew rate at the rising and falling edges of the pulse of the gate signal input to the n-channel transistor-based pixel circuit can be achieved.

The phase of the B clock set and the number of buffers may be different depending on a design request of the gate driving circuit. For example, when the G clock signal that is input to the first circuit part GIP(n) is a two-phase clock, for a two-phase B clock signal, the pulse of one gate signal may be output from the second circuit part GIP2, and for a four-phase B clock signal, two gate signals may be output from a two-stage buffer of the second circuit part GIP2. The pulses of the two gate signals may be sequentially shifted in synchronization with the four-phase B clock signal. When the G clock signal that is input to the first circuit part GIP(n) is a four-phase clock, for a four-phase B clock signal, two gate signals may be output from a two-stage buffer of the second circuit part GIP2.

The number of pulses of the gate signal that are sequentially output from one gate driving circuit may be increased depending on the phase of the clock signal and the number of buffers connected to the second circuit part GIP2. In this case, since the number of gate driving circuits that configure the gate driver and the size of the gate driving circuit are significantly reduced, it is advantageous to design a narrow bezel of the display panel.

Referring to FIG. 5, the second circuit part GIP2 includes first and second buffers BUF1 and BUF2 that share the Q node and the QB node.

After the voltage of the Q node is boosted to a voltage lower than the gate low voltage by a pulse of a fourth B clock signal BCLK4(n), when a pulse of a first B clock signal BCLK1(n) is input, a first buffer BUF1 outputs a pulse of a second output signal GOUT(n) in synchronization with the pulse of the first B clock signal BCLK1(n). Subsequently, when a pulse of a second B clock signal BCLK2(n) is input, a second buffer BUF2 outputs a pulse of a third output signal GOUT(n+1) in synchronization with the pulse of the second B clock signal BCLK2(n).

The first buffer BUF1 includes the third transistor T03 and the fourth transistor T04 described above. The second buffer BUF2 includes a fifth transistor T05 and a sixth transistor T06. The fifth transistor T05 includes a gate electrode connected to the Q node, a first electrode connected to a third B clock node 43 to which the second B clock signal BCLK2(n) is input, and a second electrode connected to a third output node from which the third output signal GOUT(n+1) is output. The sixth transistor T06 includes a gate electrode connected to the QB node, a first electrode connected to the third output node, and a second electrode connected to the VGL node.

The first circuit part GIP(n) illustrated in FIGS. 4 and 5 may be implemented by a shift register illustrated in FIG. 6 or an edge trigger illustrated in FIG. 20, but the embodiments of the present disclosure are not limited thereto.

FIG. 6 is a circuit diagram illustrating an example of a shift register circuit that can be applied to the first circuit part of the gate driving circuit illustrated in FIGS. 4 and 5. In the circuit illustrated in FIG. 6, redundant description to the second circuit part GIP2 described in the embodiments of FIGS. 4 and 5 will not be repeated.

Referring to FIG. 6, the first circuit part GIP(n) includes a Q1 node, a Q2 node, a QB node, and a plurality of transistors T21 to T28. Each of the transistors T21 to T28 may be implemented by a p-channel transistor, but the embodiments of the present disclosure are not limited thereto.

A first transistor T21 is connected between a VST node 50 and the Q2 node. The first transistor T21 is turned on in response to a fourth G clock signal GCLK4(n), and electrically connects the VST node 50 to the Q2 node. A start pulse VST or a carry signal from a first circuit part of a previous signal transmitter, for example, an (n−1)th signal transmitter or an (n−2)th signal transmitter, that is, a first output signal COUT(n−1) may be input to the VST node 50. When the first transistor T21 is turned on, the Q2 node may be discharged to the gate low voltage VGL of the VST node. The first transistor T21 includes a gate electrode connected to a first G clock node 51 to which the fourth G clock signal GCLK4(n) is input, a first electrode connected to the VST node 50, and a second electrode connected to the Q2 node.

A second transistor T22 is connected between a VGH node to which a gate high voltage VGH is applied and the Q2 node, and charges and discharges the Q2 node in response to a voltage of the QB node. When the voltage of the QB node is the gate high voltage VGH, the second transistor T22 may be turned off, and the Q2 node may be discharged to the gate low voltage VGL of the VST node. When the voltage of the QB node is the gate low voltage VGL, the second transistor T22 is turned on, and the Q2 node is electrically connected to the VGH node to which the gate high voltage VGH is applied, so that the voltage of the Q2 node may be changed to the gate high voltage VGH. The second transistor T22 includes a gate electrode connected to the QB node, a first electrode connected to the Q2 node, and a second electrode connected to the VGH node.

A third transistor T23 is connected between the VGL node to which the gate low voltage VGL is applied and the QB node. The third transistor T23 may be turned on in response to a third G clock signal GCLK3(n) and may electrically connect the VGL node to the QB node. When the third transistor T23 is turned on, the voltage of the QB node may be discharged to the gate low voltage VGL. The third transistor T23 includes a gate electrode connected to a second G clock node 52 to which the third G clock signal GCLK3(n) is input, a first electrode connected to the VGL node, and a second electrode connected to the QB node.

A fourth transistor T24 is connected between the QB node and the VGH node. The fourth transistor T24 may be turned on in response to a voltage of the VST node and may electrically connect the QB node to the VGH node. When the fourth transistor T24 is turned on, the QB node is charged with the gate high voltage VGH. The fourth transistor T24 includes a gate electrode connected to the VST node 50, a first electrode connected to the QB node, and a second electrode connected to the VGH node.

A fifth transistor T25 is connected between the Q1 node and the Q2 node. The fifth transistor T25 electrically separates the Q1 node and the Q2 node when the Q1 node is bootstrapped and reduces stress of the first transistor T21. The fifth transistor T25 includes a gate electrode connected to the VGL node, a first electrode connected to the Q1 node, and a second electrode connected to the Q2 node.

Sixth and seventh transistors T26 and T27 are output transistors that output the pulse of the first output signal COUT(n). The sixth transistor T26 is connected between a third G clock node 53 to which a second G clock signal GCLK2(n) is input and the first output node and is turned on in response to a voltage of the Q1 node. When the voltage of the Q1 node is the gate low voltage VGL, the sixth transistor T26 is turned on, and the third G clock node 53 is electrically connected to the first output node, so that a voltage of the second G clock signal GCLK2(n) may be transmitted to the first output node. The sixth transistor T26 includes a gate electrode connected to the Q1 node, a first electrode connected to the third G clock node 53 to which the second G clock signal GCLK2(n) is input, and a second electrode connected to the first output node. A capacitor CQ1 is connected between the Q1 node and the first output node. The capacitor CQ1 boosts the voltage of the Q1 node to a voltage lower than the gate low voltage with bootstrapping through capacitor coupling between the first output node and the Q1 node when a voltage of a fourth output node increases.

The seventh transistor T27 is connected between the first output node and the VGH node and is turned on in response to the voltage of the QB node. When the voltage of the QB node is the gate low voltage VGL, the seventh transistor T27 is turned on, and the first output node is connected to the VGH node, so that a voltage of the first output signal COUT(n) increases to the gate high voltage VGH. The seventh transistor T27 can prevent the occurrence of ripples in the first output signal COUT(n) during the gate high voltage interval of the first output signal COUT(n). The seventh transistor T27 includes a gate electrode connected to the QB node, a first electrode connected to the first output node, and a second electrode connected to the VGH node. A capacitor CQB is connected between the QB node and the VGH node and reduces fluctuation of the gate-source voltage of the seventh transistor T27.

An eighth transistor T28 is connected between the QB node and the VGH node and is turned on in response to the voltage of the Q2 node. When the eighth transistor T28 is turned on, the QB node is electrically connected to the VGH node. The eighth transistor T28 includes a gate electrode connected to the Q2 node, a first electrode connected to the QB node, and a second electrode connected to the VGH node.

The second transistor T22, the fourth transistor T24, and the eighth transistor T28 configure an inverter circuit INV that charges and discharges the voltage of the QB node to a voltage with a phase opposite to the voltage of the Q2 node.

As illustrated in FIG. 8, when the Q1 node is bootstrapped by a pulse of the second G clock signal GCLK2(n), the voltage of the Q1 node may be lowered to a voltage lower than the gate low voltage VGL. In this case, when a source voltage of the fifth transistor T25 may be lowered to be equal to or lower than a gate voltage, and the fifth transistor T25 may be turned off.

When the Q1 node and the Q2 node are integrated into one node and the node is bootstrapped, stress (high junction stress) of the first transistor T21 due to a drain-source voltage Vds is increased to adversely affect the lifetime of the first transistor T21. During an interval where the Q2 node is changed with the voltage of the VST node, the gate-source voltage Vgs of the fifth transistor T25 may be Vgs=VGL−VGH, and the fifth transistor T25 may be turned on.

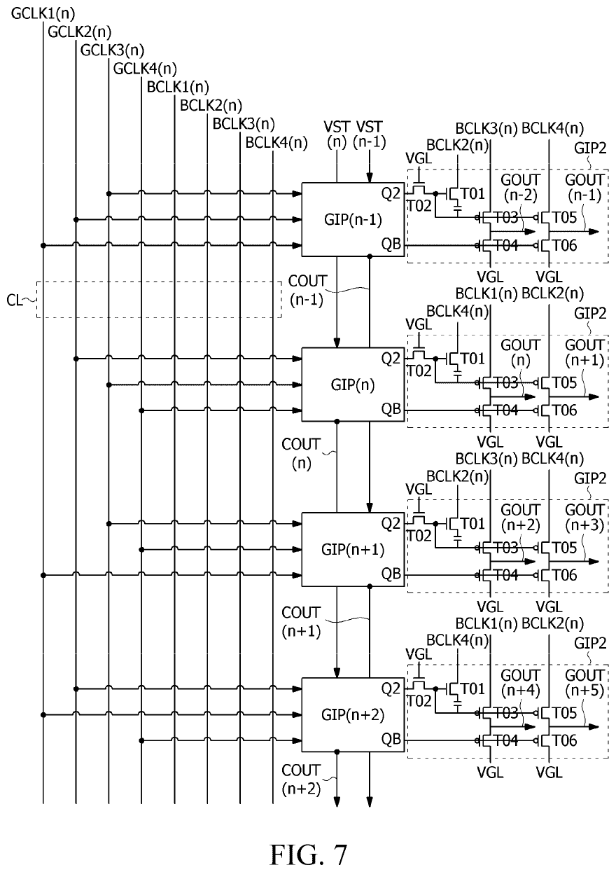

FIG. 7 is a diagram schematically illustrating a configuration of a gate driver to which the gate driving circuit illustrated in FIG. 6 can be applied. FIG. 8 is a waveform chart illustrating input and output signals of the gate driver illustrated in FIG. 7 and voltages of main nodes.

Referring to FIGS. 7 and 8, the gate driver 120 includes signal transmitters that are connected in a cascade manner via clock lines CL and carry signal lines. The signal transmitters include first circuit part GIP(n−1) to GIP(n+2) and second circuit parts GIP2, respectively.

The signal transmitters may receive a start pulse VST or first output signals COUT(n−1) to (n+2) from previous signal transmitters and clock signals GCLK1(n) to GCLK4(n) and BCLK1(n) to BCLK4(n). The clock signals GCLK1(n) to GCLK4(n) and BCLK1(n) to BCLK4(n) may be divided into a G clock set GCLK1(n) to GCLK4(n) that is input to the first circuit parts GIP(n−1) to (n+2) and a B clock set BCLK1(n) to BCLK4(n) that is input to the second circuit parts GIP2. Each of the clock signals of the G clock set GCLK1(n) to GCLK4(n) includes a pulse that is generated as the gate low voltage VGL. Each of the clock signals of the B clock set BCLK1(n) to BCLK4(n) includes a pulse that is generated as the gate high voltage VGH.

As illustrated in FIG. 8, the G clock set GCLK1(n) to GCLK4(n) and the B clock set BCLK1(n) to BCLK4(n) may be a four-phase clock in which a pulse is sequentially shifted, but the embodiments of the present disclosure are not limited thereto. The pulses of the G clock set GCLK1(n) to GCLK4(n) are shifted in an order of GCLK1(n), GCLK2(n), GCLK3(n), and GCLK4(n) on a time axis. The pulse of the clock signal is rolled, and a pulse of a fourth G clock signal GCLK4(n) is generated earlier than a pulse of a first G clock signal GCLK1(n) that is generated thereafter. The pulses of the B clock set BCLK1(n) to BCLK4(n) are shifted in an order of BCLK1(n), BCLK2(n), BCLK3(n), and BCLK4(n) on the time axis. The pulse of the clock signal is rolled, and a pulse of a fourth B clock signal BCLK4(n) is generated earlier than a pulse of a first B clock signal BCLK1(n) that is generated thereafter.

The clock signals of the B clock set BCLK1(n) to BCLK4(n) are generated as clocks with a phase opposite to the clock signals corresponding to the G clock set GCLK1(n) to GCLK4(n). For example, as illustrated in FIG. 8, the first B clock signal BCLK1(n) has a phase opposite to the first G clock signal GCLK1(n). A second B clock signal BCLK2(n) has a phase opposite to a second G clock signal GCLK2(n). A third B clock signal BCLK3(n) has a phase opposite to a third G clock signal GCLK3(n). The fourth B clock signal BCLK4(n) has a phase opposite to the fourth G clock signal GCLK4(n).

The pulses of the start pulse VST and the clock signals GCLK1(n) to GCLK4(n) and BCLK1(n) to BCLK4(n) swing between the gate high voltage VGH and the gate low voltage VGL. The pulses of first output signals COUT(n−1) to COUT(n+2) are synchronized with the pulses of the G clock set GCLK1(n) to GCLK4(n). The pulses of second and third output signals GOUT(n−2) to GOUT(n+5) are synchronized with the pulses of the B clock set BCLK1(n) to BCLK4(n). The pulses of the second and third output signals GOUT(n−2) to GOUT(n+5) swing between the gate high voltage VGH and the gate low voltage VGL similarly to the pulses of the B clock set BCLK1(n) to BCLK4(n). The gate high voltage VGH may be 7.6 V and the gate low voltage VGL may be −15.3 V, but the embodiments of the present disclosure are not limited thereto.

The p-channel transistors T01 to T06 that configure the second circuit part GIP2 is less susceptible to PBTS than an n-channel transistor. Accordingly, the second circuit part GIP2 can stably output a pulse of a gate signal capable of driving a n-channel transistor-based pixel circuit with little reduction in reliability due to PBTS, and is advantageous to design a narrow bezel of a display panel with a multiple buffer structure. Since the output transistors T03 to T06 of the buffers are little deteriorated due to accumulation of stress, excellent rising and falling characteristics can be secured in the second and third output signals GOUT(n−2) to (n+5).

As illustrated in FIG. 8, a voltage waveform of the QB node has a phase opposite to the voltages of the Q1 node, the Q2 node, and the Q node. A voltage waveform of the Q node has the same phase as the voltages of the Q1 node and the Q2 node. The first output signals COUT(n−1) to (n+2) are output as the pulse of the gate low voltage VGL in synchronization with the pulse of the second G clock signal GCLK2(n) when the Q1 node is bootstrapped by the pulses of the G clock set GCLK1(n) to GCLK4(n) and the voltage of the Q1 node becomes lower than the gate low voltage VGL. In the case of the n-th signal transmitter, the Q1 node is bootstrapped by the pulse of the second G clock signal GCLK2(n). Subsequently, in the case of the (n+1)th signal transmitter, the Q1 node is bootstrapped by the pulse of the third G clock signal GCLK3(n).

In each signal transmitter, the pulses of the second and third output signals GOUT(n−2) to (n+5) are sequentially output in synchronization with the pulses of the B clock set BCLK1(n) to BCLK4(n) that are sequentially input after pre-charging in which the Q node is bootstrapped by the pulse of the corresponding clock signal of the B clock set BCLK1(n) to BCLK4(n) and the voltage of the Q node becomes lower than the gate low voltage VGL.

In the case of the n-th signal transmitter, after the Q node is bootstrapped by the pulse of the fourth B clock signal BCLK4(n), the pulses of the first and second B clock signals BCLK1(n) and BCLK2(n) are input. Subsequently, in the n-th signal transmitter, the second output signal GOUT(n) is output in synchronization with the pulse of the first B clock signal BCLK1(n), and then, the pulse of the third output signal GOUT(n+1) is output in synchronization with the pulse of the second B clock signal BCLK2(n).

In the case of the (n+1)th signal transmitter, after the Q node is bootstrapped by the pulse of the second B clock signal BCLK2(n), the pulses of the third and fourth B clock signals BCLK3(n) and BCLK4(n) are input. Subsequently, in the (n+1)th signal transmitter, the pulse of the second output signal GOUT(n+2) is output in synchronization with the pulse of the third B clock signal BCLK3(n), and then, the pulse of the third output signal GOUT(n+3) is output in synchronization with the pulse of the third B clock signal BCLK3(n).

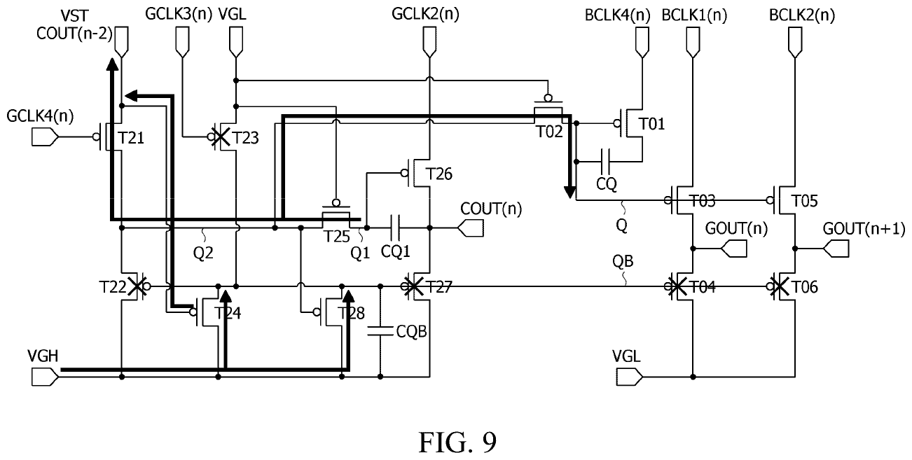

FIGS. 9 to 18 are diagrams illustrating an operation of the gate driving circuit illustrated in FIG. 6 in stages. The gate driving circuit illustrated in FIGS. 9 to 18 is the gate driving circuit of the n-th signal transmitter. The gate driving circuits of other signal transmitters are substantially the same as the gate driving circuit of the n-th signal transmitter. Since the timings of the input clock signals of the signal transmitters are different, the timings of the output signals may be different.

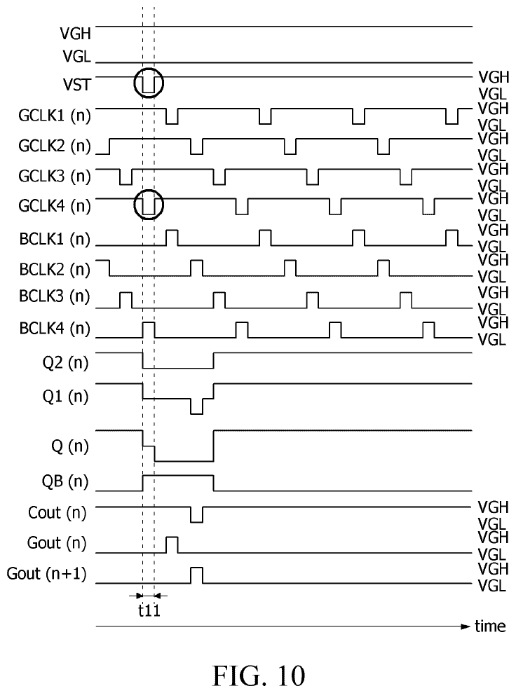

FIGS. 9 and 10 are a circuit diagram and a waveform chart illustrating an operation of the gate driving circuit illustrated in FIG. 6 in a t11 period.

Referring to FIGS. 9 and 10, the first circuit part GIP(n) receives the pulses of the start pulse VST, the fourth G clock signal GCLK4(n), and the fourth B clock signal BCLK4(n) in the t11 period. In this case, the first and fourth transistors T21 and T24 are turned on in response to the gate low voltage VGL. In the t11 period, the fifth transistor T25 and the sixth transistor T26 are turned on. The second transistor T22, the third transistor T23, and the seventh transistor T27 are turned off in the t11 period.

In the second circuit part GIP2, the first transistor T01, the second transistor T02, the third transistor T03, and the fifth transistor T05 are turned on in the t11 period. The fourth and sixth transistors T04 and T06 are turned off in the t11 period.

The voltages of the Q1 node Q1(n), the Q2 node Q2(n), and the Q node Q(n) are the gate low voltage VGL in the t11 period. The voltage of the QB node QB(n) is the gate high voltage VGH in the t11 period. The voltage of the first output signal COUT(n) is the gate high voltage VGH in the t11 period. The voltages of the second and third output signals GOUT(n) and GOUT(n+1) are the gate low voltage VGL in the t11 period.

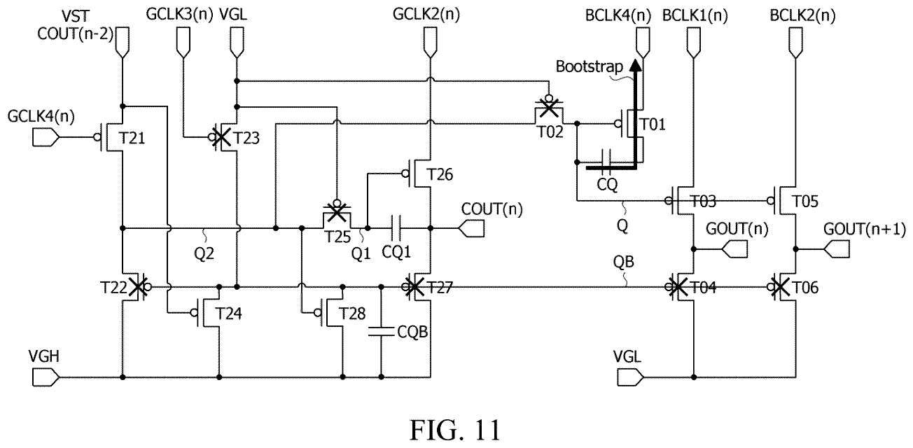

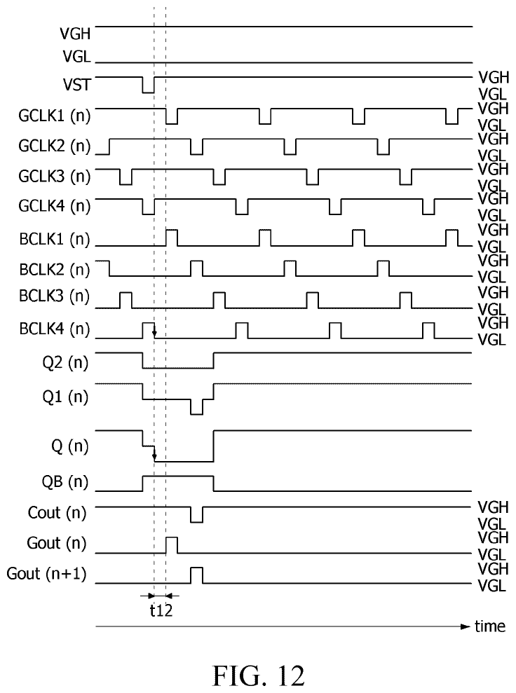

FIGS. 11 and 12 are a circuit diagram and a waveform chart illustrating an operation of the gate driving circuit illustrated in FIG. 6 in a t12 period.

Referring to FIGS. 11 and 12, when the t12 period starts, the voltage of the Q node Q(n) is boosted to a voltage lower than the gate low voltage VGL due to bootstrapping at a falling edge of the fourth B clock signal BCLK4(n). In the first circuit part GIP(n), the first transistor T21, the fourth transistor T24, the sixth transistor T26, and the eighth transistor T28 are turned on in the t12 period. The second transistor T22, the third transistor T23, the fifth transistor T25, and the seventh transistor T27 are turned off in the t12 period.

In the second circuit part GIP2, the first transistor T01, the third transistor T03, and the fifth transistor T05 are turned on in the t12 period. The second transistor T02, the fourth transistor T04, and the sixth transistor T06 are turned off in the t12 period.

The voltages of the Q1 node Q1(n) and the Q2 node Q2(n) are the gate low voltage VGL in the t12 period. The voltage of the QB node QB(n) is the gate high voltage VGH in the t12 period. The voltage of the first output signal COUT(n) is the gate high voltage VGH in the t12 period. The voltages of the second and third output signal GOUT(n) and GOUT(n+1) are the gate low voltage VGL in the t12 period.

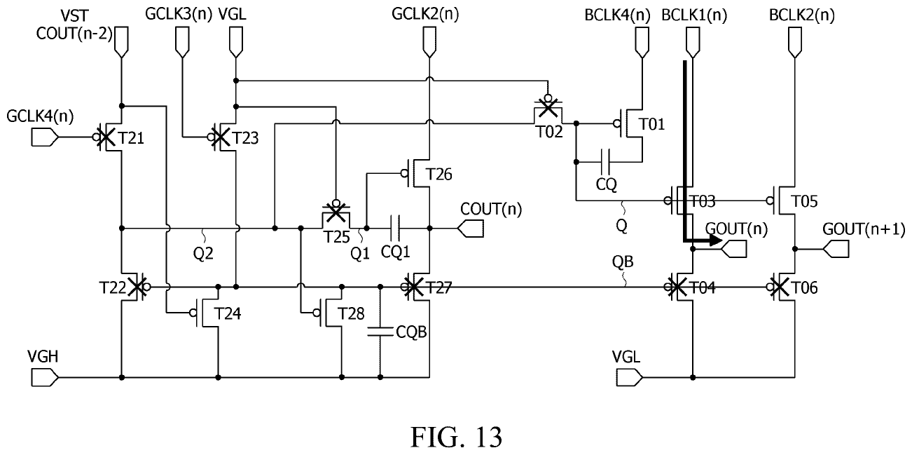

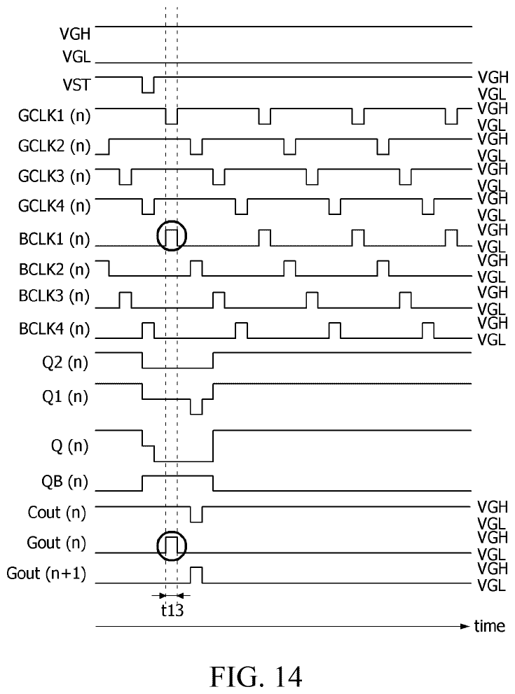

FIGS. 13 and 14 are a circuit diagram and a waveform chart illustrating an operation of the gate driving circuit illustrated in FIG. 6 in a t13 period.

Referring to FIGS. 13 and 14, in the t13 period, the pulse of the first B clock signal BCLK1(n) is generated as the gate high voltage VGH. In this case, the gate high voltage VGH of the first B clock signal BCLK1(n) is transmitted to the second output node via the third transistor T03 of the second circuit part GIP2 and the pulse of the second output signal GOUT(n) is output as the gate high voltage VGH.

In the first circuit part GIP(n), the fourth transistor T24, the sixth transistor T26, and the eighth transistor T28 are turned on in the t13 period. The first transistor T21, the second transistor T22, the third transistor T23, the fifth transistor T25, and the seventh transistor T27 are turned off in the t13 period.

In the second circuit part GIP2, the first transistor T01, the third transistor T03, and the fifth transistor T05 are turned on in the t13 period. The second transistor T02, the fourth transistor T04, and the sixth transistor T06 are turned off in the t13 period.

The voltages of the Q1 node Q1(n) and the Q2 node Q2(n) are the gate low voltage VGL in the t13 period. The voltage of the Q node Q(n) is the gate low voltage VGL in the t13 period. The voltage of the QB node QB(n) is the gate high voltage VGH in the t13 period. The voltage of the first output signal COUT(n) is the gate high voltage VGH in the t13 period. The voltage of the second output signal GOUT(n) is the gate high voltage VGH in the t13 period. The voltage of the third output signal GOUT(n+1) is the gate low voltage VGL in the t13 period.

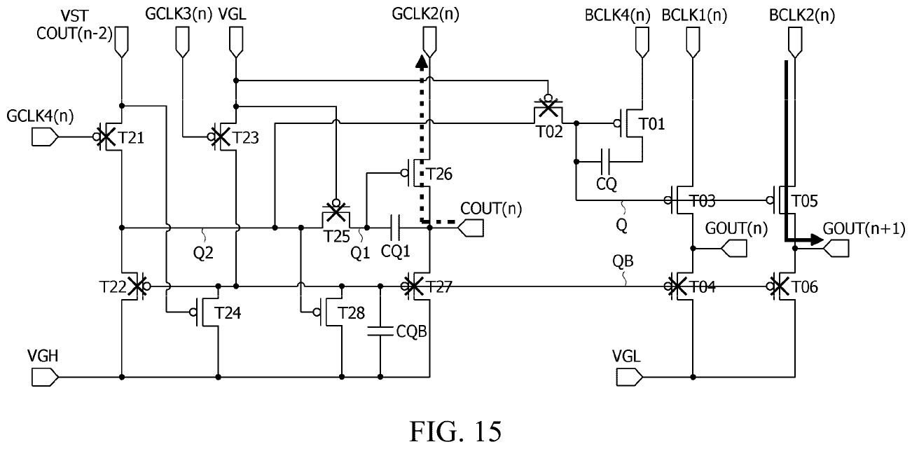

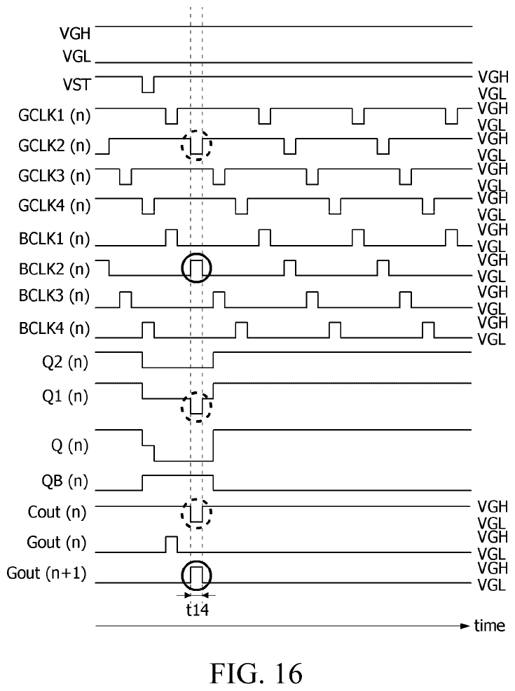

FIGS. 15 and 16 are a circuit diagram and a waveform chart illustrating an operation of the gate driving circuit illustrated in FIG. 6 in a t14 period.

Referring to FIGS. 15 and 16, the pulse of the second G clock signal GCLK2(n) is generated as the gate low voltage VGL in the t14 period. In this case, the voltage of the Q1 node Q1(n) is boosted to a voltage lower than the gate low voltage VGL due to bootstrapping, and the voltage of the first output signal COUT(n) is discharged to the third G clock node to which the second G clock signal GCLK2(n) is input and is lowered to the gate low voltage VGL.

The pulse of the second B clock signal BCLK2(n) is generated as the gate high voltage VGH in the t14 period. In this case, the gate high voltage VGH of the second B clock signal BCLK2(n) is transmitted to the third output node via the fifth transistor T05 of the second circuit part GIP2 and the pulse of the third output signal GOUT(n+1) is output as the gate high voltage VGH.

In the first circuit part GIP(n), the fourth transistor T24, the sixth transistor T26, and the eighth transistor T28 are turned on in the t14 period. The first transistor T21, the second transistor T22, the third transistor T23, the fifth transistor T25, and the seventh transistor T27 are turned off in the t14 period.

In the second circuit part GIP2, the first transistor T01, the third transistor T03, and the fifth transistor T05 are turned on in the t14 period. The second transistor T02, the fourth transistor T04, and the sixth transistor T06 are turned off in the t14 period.

The voltage of the Q1 node Q1(n) is a voltage lower than the gate low voltage VGL in the t14 period. The voltage of the Q2 node Q2(n) is the gate low voltage VGL in the t14 period. The voltage of the Q node Q(n) is a voltage lower than the gate low voltage VGL in the t14 period. The voltage of the QB node QB(n) is the gate high voltage VGH in the t14 period. The voltage of the first output signal COUT(n) is the gate low voltage VGL in the t14 period. The voltage of the second output signal GOUT(n) is the gate low voltage VGL in the t14 period. The voltage of the third output signal GOUT(n+1) is the gate high voltage VGH in the t14 period.

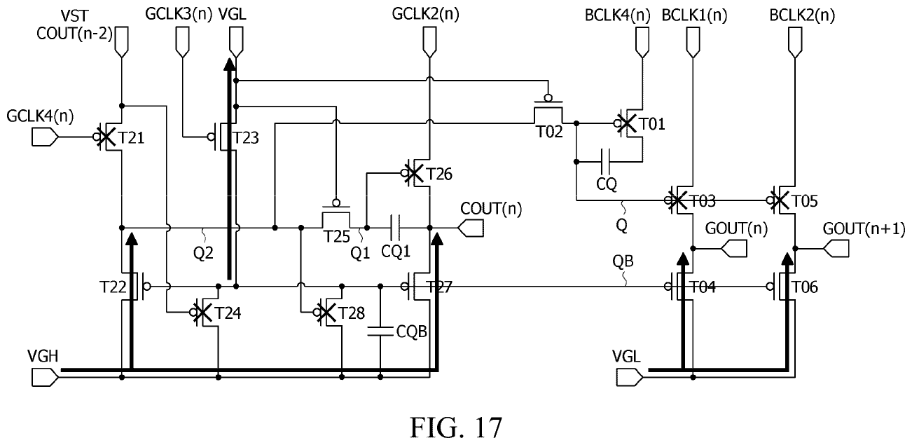

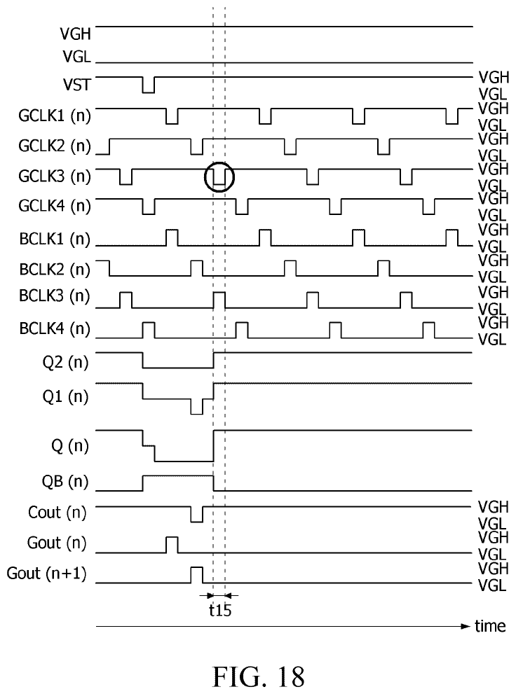

FIGS. 17 and 18 are a circuit diagram and a waveform chart illustrating an operation of the gate driving circuit illustrated in FIG. 6 in a t15 period.

Referring to FIGS. 17 and 18, the pulse of the third G clock signal GCLK3(n) is generated as the gate low voltage VGL in the t15 period. In this case, the voltage of the QB node QB(n) is discharged to the gate low voltage VGL. In the first circuit part GIP(n), the second transistor T22, the third transistor T23, the fifth transistor T25, and the seventh transistor T27 are turned on in the t15 period. The first transistor T21, the fourth transistor T24, the sixth transistor T26, and the eighth transistor T28 are turned off in the t15 period.

The voltages of the first B clock signal BCLK1(n), the second B clock signal BCLK2(n), and the fourth B clock signal BCLK4(n) are the gate low voltage VGL in the t15 period. As a result, in the second circuit part GIP2, the second transistor T02, the fourth transistor T04, and the sixth transistor T06 are turned on in the t15 period. The first transistor T01, the third transistor T03, and the fifth transistor T05 are turned off in the t15 period.

The voltages of the Q1 node Q1(n), the Q2 node Q2(n), and the Q node Q(n) are the gate high voltage VGH in the t15 period. The voltage of the QB node QB(n) is the gate low voltage VGL in the t15 period. The voltage of the first output signal COUT(n) is the gate high voltage VGH in the t15 period. The voltages of the second and third output signals GOUT(n) and GOUT(n+1) are the gate low voltage VGL in the t15 period.

FIG. 19 is a diagram illustrating a simulation result of the gate driving circuit illustrated in FIG. 6. In FIG. 19, the horizontal axis represents time [s] and the vertical axis represents a voltage [V]. As will be understood from FIG. 19, the gate driving circuit illustrated in FIG. 6 can sequentially output pulses of second and third output signals GOUT1 and GOUT2 for switching the n-channel transistors of the pixel circuit.

FIG. 20 is a circuit diagram illustrating an example of an edge trigger circuit that can be applied to the first circuit part of the gate driving circuit illustrated in FIGS. 4 and 5. The edge trigger circuit may output a signal the voltage of which varies at an edge of a clock, and is used to output a signal having a pulse interval (pulse width) of one horizontal period or more. A gate signal output from the edge trigger circuit may be applied in common to pixels of two pixel lines or more. In the circuit illustrated in FIG. 20, redundant description to the second circuit part GIP2 described in the embodiments of FIGS. 4 and 5 will not be repeated.

Referring to FIG. 20, a first circuit part GIP(n) includes a Q1 node, a Q2 node, a QB node, and a plurality of transistors T31 to T37. Each of the transistors T31 to T37 may be implemented by a p-channel transistor, but the embodiments of the present disclosure are not limited thereto.

A first transistor T31 is connected between a VST node 60 and the Q2 node. The first transistor T31 is turned on in response to a first G clock signal GCLK1(n) and electrically connects the VST node 60 to the Q2 node. A start pulse VST or a carry signal from a first circuit part of a previous signal transmitter, for example, an (n−1)th signal transmitter or (n−2)th signal transmitter, that is, a first output signal COUT(n−1) is input to the VST node 60. When the first transistor T31 is turned on, a voltage of the Q2 node may be discharged to a gate low voltage VGL of the VST node 60. The first transistor T31 includes a gate electrode connected to a G clock node 61 to which the first G clock signal GCLK1(n) is input, a first electrode connected to the VST node 60, and a second electrode connected to the Q2 node.

A capacitor CON is connected between the G clock node 61 and gate electrodes of third transistors T331 and T332. A second transistor T32 charges and discharges the gate electrodes of the third transistors T331 and T332 in response to a voltage of the VST node 60. When the second transistor T32 is turned off in response to a gate high voltage VGH of the VST node 60, the third transistors T331 and T332 may be turned on in response to a voltage of the G clock node 61 to which the gate electrodes of the third transistors T331 and T332 are coupled via the capacitor CON. When the second transistor T32 is turned on in response to the gate low voltage VGL of the VST node 60, a VGH node may be electrically connected to the gate electrodes of the third transistors T331 and T332 and the third transistors T331 and T332 may be turned off. The second transistor T32 includes a gate electrode connected to the VST node 60, a first electrode connected to the capacitor CON and the gate electrodes of the third transistors T331 and T332, and a second electrode connected to the VGH node. The first electrode of the second transistor T32 is coupled to the G clock node 61 via the capacitor CON.

The third transistors T331 and T332 may electrically connect the G clock node 61 to the QB node according to a voltage that is input to the gate electrodes. When the third transistors T331 and T332 are a single transistor, the third transistors T331 and T332 include a gate electrode coupled to the G clock node 61 via the capacitor CON, a first electrode connected to the G clock node 61, and a second electrode connected to the QB node. The third transistors T331 and T332 may be implemented by a dual transistor as illustrated in FIG. 20. In this case, a third-first transistor T331 includes a gate electrode connected to the capacitor CON and the first electrode of the second transistor T32, a first electrode connected to the G clock node 61, and a second electrode connected to a first electrode of a third-second transistor T332. The third-second transistor T332 includes a gate electrode connected to the capacitor CON and the first electrode of the second transistor T32, a first electrode connected to the second electrode of the third-first transistor T331, and a second electrode connected to the QB node.

A fourth transistor T34 is connected between the QB node and the VGH node. The fourth transistor T34 may be turned on in response to the voltage of the Q2 node and may electrically connect the QB node to the VGH node. When the fourth transistor T34 is turned on, the QB node may be charged with the gate high voltage VGH. The fourth transistor T34 includes a gate electrode connected to the Q2 node, a first electrode connected to the QB node, and a second electrode connected to the VGH node.

The third and fourth transistors T331, T332, and T34 configure an inverter circuit INV that charges and discharges the voltage of the QB node to a voltage with a phase opposite to the voltage of the Q2 node.

A fifth transistor T35 is connected between the Q1 node and the Q2 node. When the Q2 node is discharged to the gate low voltage VGL, the Q1 node may be discharged to the gate low voltage VGL via the fifth transistor T35. When the Q1 node reaches the gate low voltage VGL, a gate-source voltage of the fifth transistor T35 may become Vgs=VGL−VGL=0 V and the fifth transistor T35 may be turned off. In this case, the Q1 node and the Q2 node may be electrically separated. When the voltage of the Q2 node is charged with the gate high voltage VGH, the Q1 node may be charged with the gate high voltage VGH via the fifth transistor T35. The fifth transistor T35 includes a gate electrode connected to a VGL node, a first electrode connected to the Q1 node, and a second electrode connected to the Q2 node.

Sixth and seventh transistors T36 and T37 are output transistors that output a pulse of a first output signal COUT(n). The sixth transistor T36 is connected between the VGL node and a first output node, and is turned on in response to a voltage of the Q1 node. When the voltage of the Q1 node is the gate low voltage VGL, the sixth transistor T36 is turned on, and the VGL node is e electrically connected to the first output node, so that a voltage of the first output node may be discharged to the gate low voltage VGL. The sixth transistor T36 includes a gate electrode connected to the Q1 node, a first electrode connected to the VGL node, and a second electrode connected to the first output node. A capacitor CQ1 is connected between the Q1 node and the first output node.

The seventh transistor T37 is connected between the first output node and a VGH node, and is turned on in response to the voltage of the QB node. When the voltage of the QB node is the gate low voltage VGL, the seventh transistor T37 is turned on, and the first output node is connected to the VGH node, so that a voltage of the first output signal COUT(n) increases to the gate high voltage VGH. The seventh transistor T37 includes a gate electrode connected to the QB node, a first electrode connected to the first output node, and a second electrode connected to the VGH node. A capacitor CQB is connected between the QB node and the VGH node.

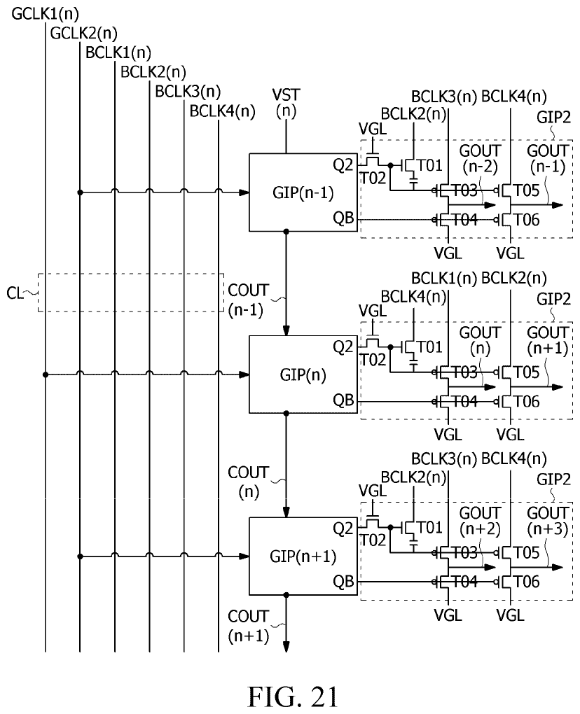

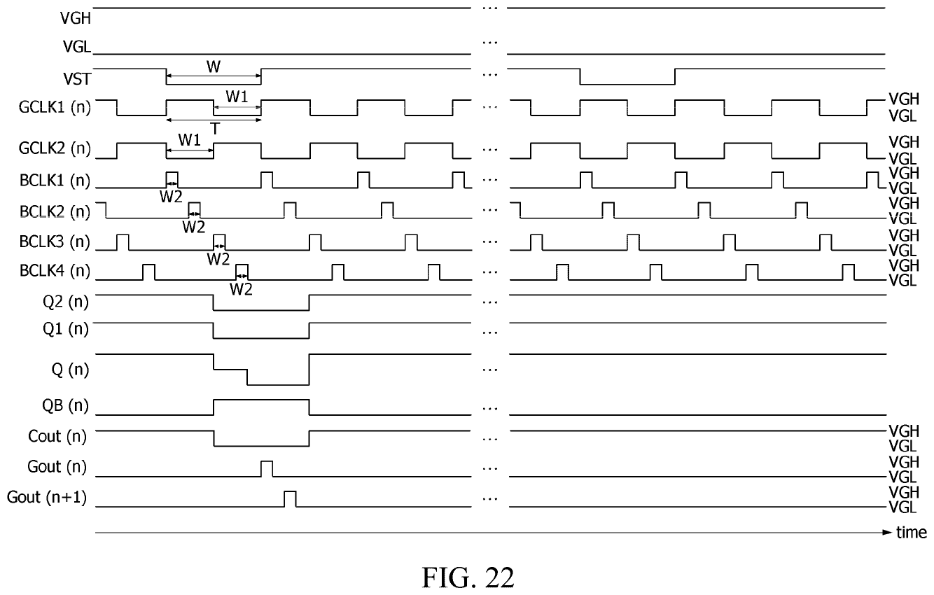

FIG. 21 is a diagram schematically illustrating a configuration of a gate driver to which the gate driving circuit illustrated in FIG. 20 can be applied. FIG. 22 is a waveform chart illustrating input and output signals of the gate driver illustrated in FIG. 21 and voltages of main nodes.

Referring to FIGS. 21 and 22, a gate driver 120 includes signal transmitters that are connected in a cascade manner via clock lines CL and carry signal lines. The signal transmitters include first circuit parts GIP(n−1) to (n+1) and second circuit parts GIP2, respectively.

The signal transmitters may receive a start pulse VST or first output signals COUT(n−1) and COUT(n+1) from previous signal transmitters and clock signals GCLK1, GCLK2, and BCLK1 to BCLK4. The clock signals GCLK1, GCLK2, and BCLK1 to BCLK4 may be divided into a G clock set GCLK1 and GCLK2 that is input to the first circuit parts GIP(n−1) to (n+1) and a B clock set BCLK1 to BCLK4 that is input to the second circuit parts GIP2. As illustrated in FIG. 22, the G clock set GCLK1 and GCLK2 may be rolled as a two-phase clock the pulse of which is sequentially shifted, but the embodiments of the present disclosure are not limited thereto. The B clock set BCLK1 to BCLK4 may be a four-phase clock the pulse of which is sequentially shifted, but the embodiments of the present disclosure are not limited thereto. The pulses of the B clock set BCLK1 to BCLK4 are shifted and rolled in an order of BCLK1(n), BCLK2(n), BCLK3(n), and BCLK4(n) on the time axis.

The pulse of the start pulse VST is generated as a gate low voltage VGL. A pulse interval (or a pulse width) W of the start pulse VST is greater than a pulse interval W1 of the G clock set GCLK1 and GCLK2 and a pulse interval W2 of the B clock set BCLK1 to BCLK4. The pulse interval W1 of the G clock set GCLK1 and GCLK2 is greater than the pulse interval W2 of the B clock set BCLK1 to BCLK4.

A pulse interval voltage of the first output signal COUT(n) is the gate low voltage VGL. The voltage of the first output signal COUT(n) is inverted at a falling edge of the G clock signal GCLK1(n) or GCLK2(n) that is input to the first circuit part GIP(n). A pulse interval of the first output signal COUT(n) may be greater than a pulse interval of each of second and third output signal GOUT(n) and GOUT(n+1). The pulse interval of the first output signal COUT(n) may be one pulse cycle T of the G clock signal GCLK1(n) or GCLK2(n). A pulse interval voltage of each of the second and third output signal GOUT(n) and GOUT(n+1) is the gate high voltage VGH.

A pulse of the second output signal GOUT(n) is synchronized with a pulse of a B clock signal BCLK1, BCLK2, BCLK3, or BCLK4 that is input to the third transistor T03 of the second circuit part GIP2. Subsequently, a pulse of the third output signal GOUT(n+1) is synchronized with a pulse of a B clock signal BCLK1, BCLK2, BCLK3, or BCLK4 that is input to the fifth transistor T05 of the second circuit part GIP2. For example, in the n-th signal transmitter, the pulse of the second output signal GOUT(n) is synchronized with a pulse of a first B clock signal BCLK1(n) that is input to the third transistor T03. Subsequently, in the n-th signal transmitter, the pulse of the third output signal GOUT(n+1) is synchronized with a pulse of a second B clock signal BCLK2(n) that is input to the fifth transistor T05. Subsequently, in the (n+1)th signal transmitter, the pulse of the second output signal GOUT(n) is synchronized with a pulse of a third B clock signal BCLK3(n) that is input to the third transistor T03. Subsequently, in the (n+1)th signal transmitter, the pulse of the third output signal GOUT(n+1) is synchronized with a pulse of a fourth B clock signal BCLK4(n) that is input to the fifth transistor T05.

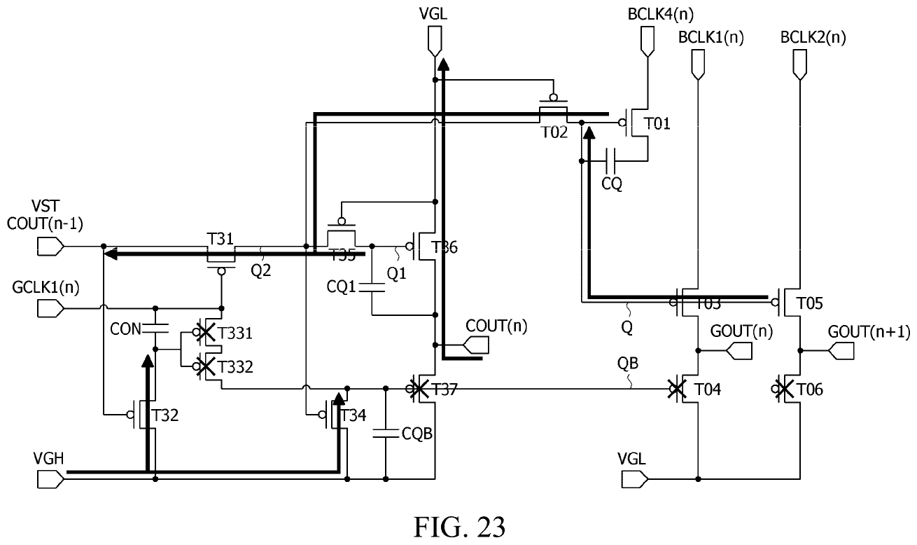

FIGS. 23 to 32 are diagrams illustrating an operation of the gate driving circuit illustrated in FIG. 20 in stages. The gate driving circuit illustrated in FIGS. 23 to 32 is the gate driving circuit of the n-th signal transmitter. The gate driving circuits of other signal transmitters are substantially the same as the gate driving circuit of the n-th signal transmitter. Since the timings of the input clock signals of the signal transmitters are different, the timings of the output signals may be different.

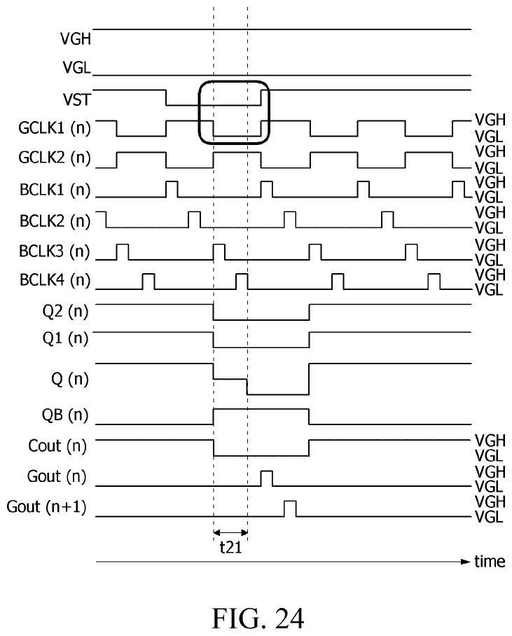

FIGS. 23 and 24 are a circuit diagram and a waveform chart illustrating an operation of the gate driving circuit illustrated in FIG. 20 in a t21 period.

Referring to FIGS. 23 and 24, the first circuit part GIP(n) receives the pulses of the start pulse VST and the first G clock signal GCLK1(n) in the t21 period. In this case, the first and second transistors T31 and T32 are turned on in response to the gate low voltage VGL. In the t21 period, the fourth transistor T34, the fifth transistor T35, and the sixth transistor T36 are turned on. The third transistors T331 and T332 and the seventh transistor T37 are turned off in the t21 period.

In the second circuit part GIP2, the first transistor T01, the second transistor T02, the third transistor T03, and the fifth transistor T05 are turned on in the t21 period. The fourth and sixth transistors T04 and T06 are turned off in the t21 period.

The voltages of the Q1 node Q1(n), the Q2 node Q2(n), and the Q node Q(n) are the gate low voltage VGL in the t21 period. The voltage of the QB node QB(n) is the gate high voltage VGH in the t21 period. The voltage of the first output signal COUT(n) is the gate low voltage VGL in the t21 period. The voltages of the second and third output signal GOUT(n) and GOUT(n+1) are the gate low voltage VGL in the t21 period.

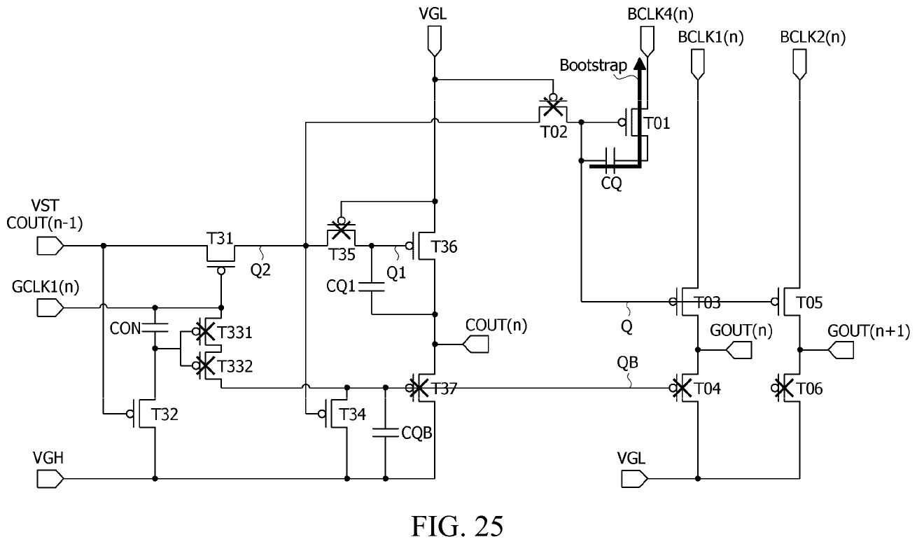

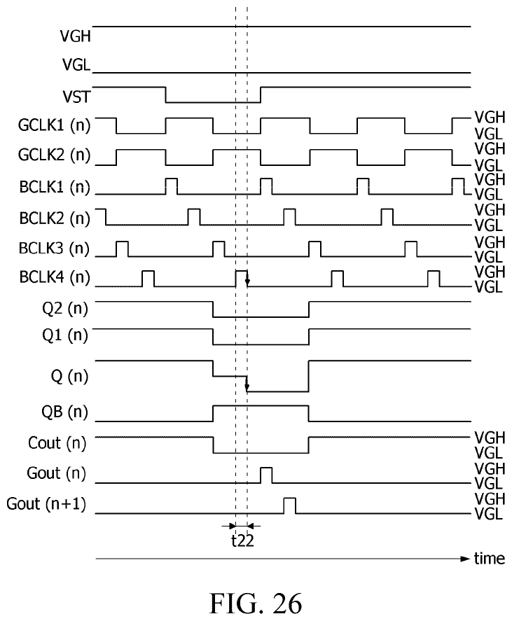

FIGS. 25 and 26 are a circuit diagram and a waveform chart illustrating an operation of the gate driving circuit illustrated in FIG. 20 in a t22 period.

Referring to FIGS. 25 and 26, in the t22 period, the voltage of the Q node Q(n) is boosted to a voltage lower than the gate low voltage VGL due to bootstrapping at a falling edge of the fourth B clock signal BCLK4(n). In the first circuit part GIP(n), the first transistor T31, the second transistor T32, the fourth transistor T34, and the sixth transistor T36 are turned on in the t22 period. The third transistors T331 and T332, the fifth transistor T35, and the seventh transistor T37 are turned off in the t22 period.

In the second circuit part GIP2, the first transistor T01, the third transistor T03, and the fifth transistor T05 are turned on in the t22 period. The second transistor T02, the fourth transistor T04, and the sixth transistor T06 are turned off in the t22 period.

The voltages of the Q1 node Q1(n) and the Q2 node Q2(n) are the gate low voltage VGL in the t22 period. The voltage of the QB node QB(n) is the gate high voltage VGH in the t22 period. The voltage of the first output signal COUT(n) is the gate low voltage VGL in the t22 period. The voltages of the second and third output signal GOUT(n) and GOUT(n+1) are the gate low voltage VGL in the t22 period.

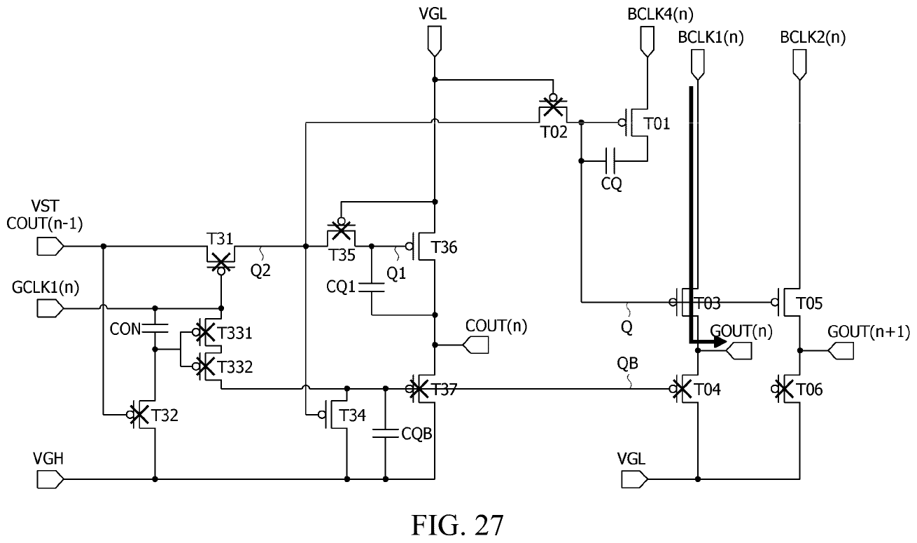

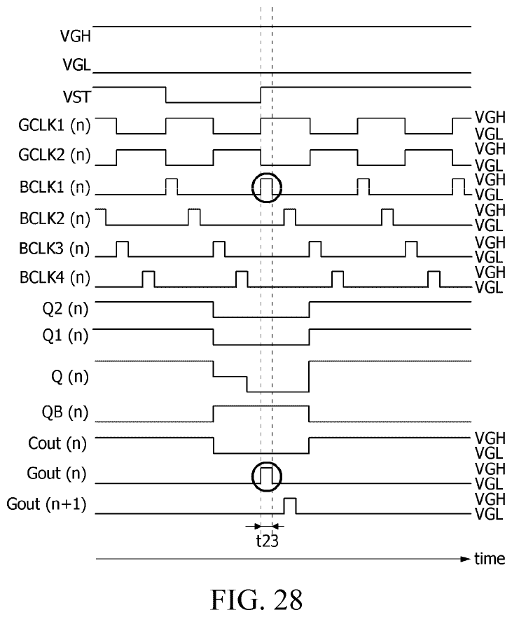

FIGS. 27 and 28 are a circuit diagram and a waveform chart illustrating an operation of the gate driving circuit illustrated in FIG. 20 in a t23 period.

Referring to FIGS. 27 and 28, in the t23 period, the pulse of the first B clock signal BCLK1(n) is generated as the gate high voltage VGH. In this case, the gate high voltage VGH of the first B clock signal BCLK1(n) is transmitted to a second output node via the third transistor T03 of the second circuit part GIP2 and the pulse of the second output signal GOUT(n) is output as the gate high voltage VGH.

In the first circuit part GIP(n), the fourth transistor T34 and the sixth transistor T36 are turned on in the t23 period. The first transistor T31, the second transistor T32, the third transistors T331 and T332, the fifth transistor T35, and the seventh transistor T37 are turned off in the t23 period.

In the second circuit part GIP2, the first transistor T01, the third transistor T03, and the fifth transistor T05 are turned on in the t23 period. The second transistor T02, the fourth transistor T04, and the sixth transistor T06 are turned off in the t23 period.

The voltages of the Q1 node Q1(n) and the Q2 node Q2(n) are the gate low voltage VGL in the t23 period. The voltage of the Q node Q(n) is a voltage lower than the gate low voltage VGL in the t23 period. The voltage of the QB node QB(n) is the gate high voltage VGH in the t23 period. The voltage of the first output signal COUT(n) is the gate low voltage VGL in the t23 period. The voltage of the second output signal GOUT(n) is the gate high voltage VGH in the t23 period. The voltage of the third output signal GOUT(n+1) is the gate low voltage VGL in the t23 period.

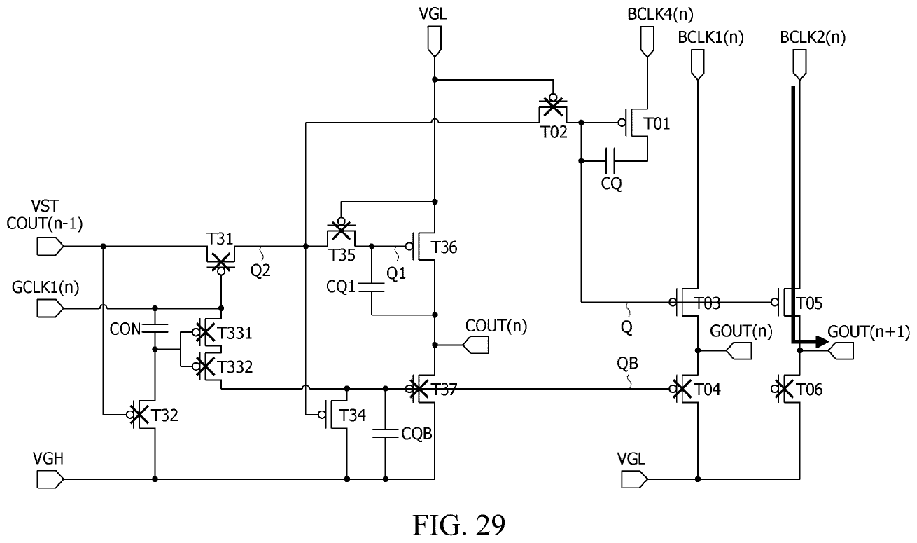

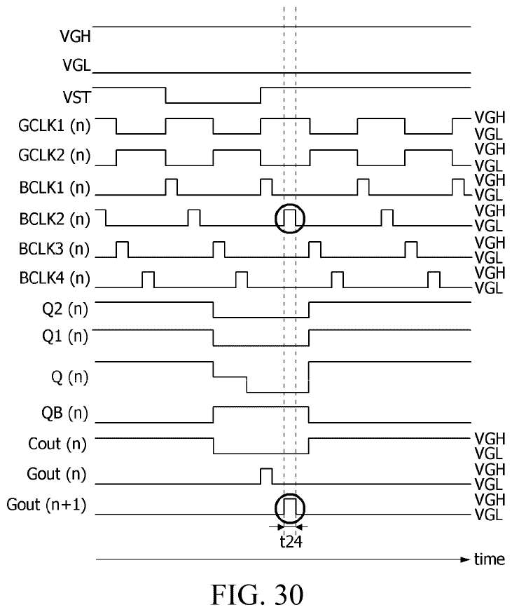

FIGS. 29 and 30 are a circuit diagram and a waveform chart illustrating an operation of the gate driving circuit illustrated in FIG. 20 in a t24 period.

Referring to FIGS. 29 and 30, the pulse of the second B clock signal BCLK2(n) is generated as the gate high voltage VGH in the t24 period. In this case, the gate high voltage VGH of the second B clock signal BCLK2(n) is transmitted to a third output node via the fifth transistor T05 of the second circuit part GIP2 and the pulse of the third output signal GOUT(n+1) is output as the gate high voltage VGH.

In the first circuit part GIP(n), the fourth transistor T34 and the sixth transistor T36 are turned on in the t24 period. The first transistor T31, the second transistor T32, the third transistors T331 and T332, the fifth transistor T35, and the seventh transistor T37 are turned off in the t24 period.

In the second circuit part GIP2, the first transistor T01, the third transistor T03, and the fifth transistor T05 are turned on in the t24 period. The second transistor T02, the fourth transistor T04, and the sixth transistor T06 are turned off in the t24 period.

The voltages of the Q1 node Q1(n) and the Q2 node Q2(n) are the gate low voltage VGL in the t24 period. The voltage of the Q node Q(n) is a voltage lower than the gate low voltage VGL in the t24 period. The voltage of the QB node QB(n) is the gate high voltage VGH in the t24 period. The voltage of the first output signal COUT(n) is the gate low voltage VGL in the t24 period. The voltage of the second output signal GOUT(n) is the gate low voltage VGL in the t24 period. The voltage of the third output signal GOUT(n+1) is the gate high voltage VGH in the t24 period.

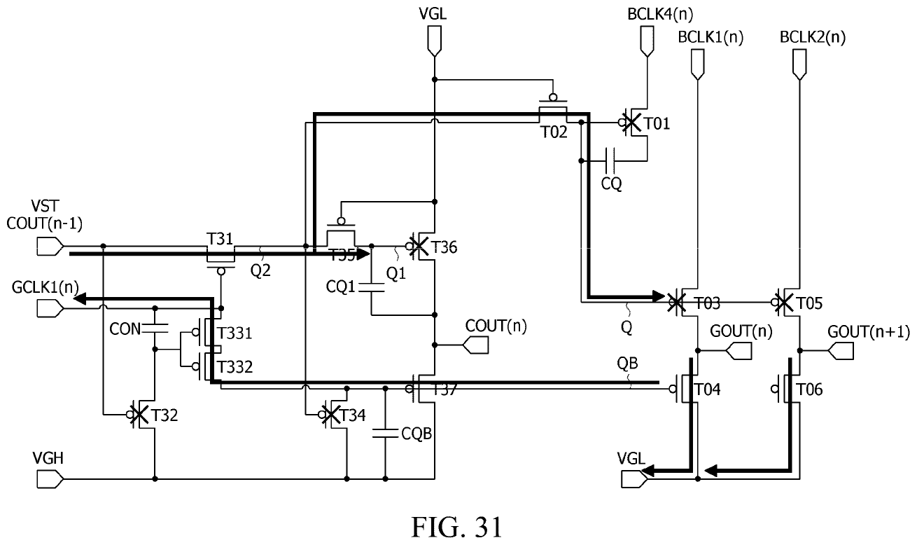

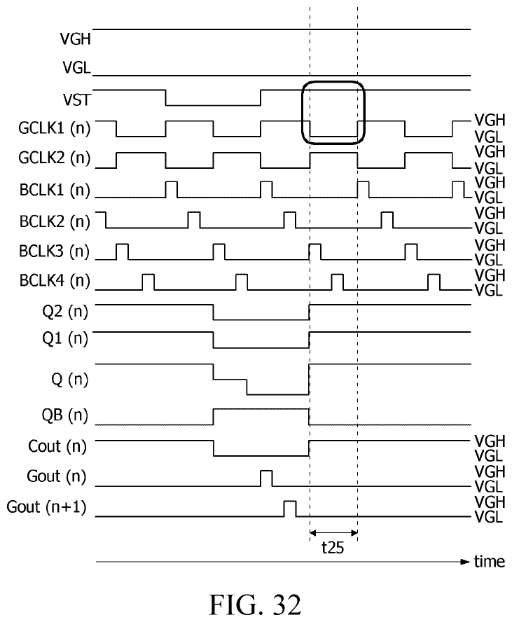

FIGS. 31 and 32 are a circuit diagram and a waveform chart illustrating an operation of the gate driving circuit illustrated in FIG. 20 in a t25 period.

Referring to FIGS. 31 and 32, the pulse of the first G clock signal GCLK1(n) is generated as the gate low voltage VGL in the t25 period. In this case, the voltage of the QB node QB(n) is discharge to the gate low voltage VGL. In the first circuit part GIP(n), the first transistor T31, the third transistors T331 and T332, the fifth transistor T35, and the seventh transistor T37 are turned on in the t25 period. The second transistor T32, the fourth transistor T34, and the sixth transistor T36 are turned off in the t25 period.

In the second circuit part GIP2, the second transistor T02, the fourth transistor T04, and the sixth transistor T06 are turned on in the t25 period. The first transistor T01, the third transistor T03, and the fifth transistor T05 are turned off in the t25 period.

The voltages of the Q1 node Q1(n), Q2 node Q2(n), and the Q node Q(n) are the gate high voltage VGH in the t25 period. The voltage of the QB node QB(n) is the gate low voltage VGL in the t25 period. The voltage of the first output signal COUT(n) is the gate high voltage VGH in the t25 period. The voltages of the second and third output signal GOUT(n) and GOUT(n+1) are the gate low voltage VGL in the t25 period.

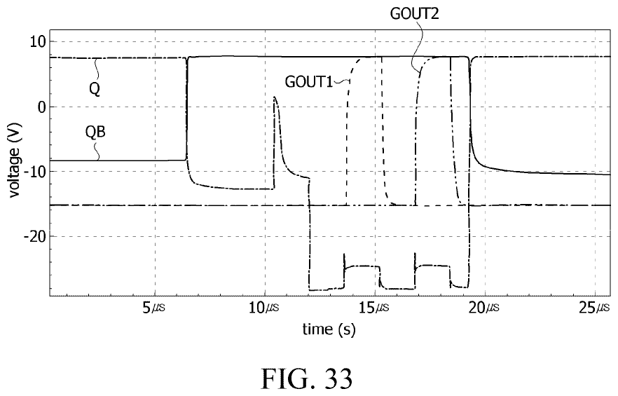

FIG. 33 is a diagram illustrating a simulation result of the gate driving circuit illustrated in FIG. 20. In FIG. 33, the horizontal axis represents time According to one or more embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the present disclosure may be applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A gate driving circuit comprising:
a first circuit part that includes a Q1 node, a Q2 node, and a QB node and is configured to receive a G clock signal and a start signal or a carry signal and output a pulse of a first output signal via a first output node; and
a second circuit part that includes a Q node, is connected to the QB node, and is configured to receive at least one B clock signal and output a pulse of a second output signal,
wherein the G clock signal includes a pulse of a first gate voltage, and the B clock signal includes a pulse of a second gate voltage lower than the first gate voltage.

2. The gate driving circuit according to claim 1, wherein the second circuit part includes:
a second-first transistor including a gate electrode connected to the Q node, a first electrode connected to a first B clock node, and a second electrode;
a second-second transistor including a gate electrode connected to a VGL node configured to receive the second gate voltage, a first electrode connected to the Q2 node, and a second electrode connected to the Q node;
a capacitor connected between the Q node and the second electrode of the second-first transistor;
a second-third transistor configured to be turned on in response to a voltage of the Q node and to transmit a voltage of a first B clock signal that is input to a second B clock node, to a second output node from which the pulse of the second output signal is output; and
a second-fourth transistor configured to be turned on in response to a voltage of the QB node and to electrically connect the second output node to the VGL node.

3. The gate driving circuit according to claim 2, wherein a pulse of a fourth B clock signal that is input to the first B clock node is configured to be generated earlier than a pulse of the first B clock signal that is input to the second B clock node.

4. The gate driving circuit according to claim 2, wherein:
the first circuit part includes a plurality of p-channel transistors, and
each of the second-first transistor, the second-second transistor, the second-third transistor, and the second-fourth transistor of the second circuit part is a p-channel transistor.

5. The gate driving circuit according to claim 4, wherein, the second circuit part further includes:
a second-fifth transistor configured to be turned on in response to the voltage of the Q node and to transmit a voltage of a second B clock signal that is input to a third B clock node, to a third output node; and
a second-sixth transistor configured to be turned on in response to the voltage of the QB node and to electrically connect the third output node to the VGL node, and
each of the second-fifth transistor and the second-sixth transistor of the second circuit part is a p-channel transistor,
wherein, the second circuit part is configured to output the pulse of the second output signal via the second output node in synchronization with a pulse of the first B clock signal and then output a pulse of a third output signal via the third output node in synchronization with a pulse of the second B clock signal.

6. The gate driving circuit according to claim 4, wherein the first circuit part includes a shift register including the plurality of p-channel transistors or an edge trigger including the plurality of p-channel transistors.

7. The gate driving circuit according to claim 4, wherein the first circuit part includes:
a first-first transistor including a gate electrode connected to a first G clock node, a first electrode connected to a VST node configured to receive a start signal or a carry signal, and a second electrode connected to the Q2 node;
a first-second transistor including a gate electrode connected to the QB node, a first electrode connected to the Q2 node, and a second electrode connected to a VGH node configured to receive the first gate voltage;
a first-third transistor including a gate electrode connected to a second G clock node, a first electrode connected to the VGL node, and a second electrode connected to the QB node;
a first-fourth transistor including a gate electrode connected to the VST node, a first electrode connected to the QB node, and a second electrode connected to the VGH node;
a first-fifth transistor including a gate electrode connected to the VGL node, a first electrode connected to the Q1 node, and a second electrode connected to the Q2 node;
a first-sixth transistor including a gate electrode connected to the Q1 node, a first electrode connected to a third G clock node, and a second electrode connected to the first output node configured to output the pulse of the first output signal;
a first-seventh transistor including a gate electrode connected to the QB node, a first electrode connected to the first output node, and a second electrode connected to the VGH node; and
a first-eighth transistor including a gate electrode connected to the Q2 node, a first electrode connected to the QB node, and a second electrode connected to the VGH node.

8. The gate driving circuit according to claim 7, wherein a B clock signal that is input to the first B clock node is a signal with a phase opposite to a phase of a G clock signal that is input to the first G clock node.

9. The gate driving circuit according to claim 7, wherein:
the voltage of the Q node has the same phase as voltages of the Q1 node and the Q2 node, and
the voltage of the QB node have a phase opposite to the voltages of the Q node, the Q1 node, and the Q2 node.

10. The gate driving circuit according to claim 7, wherein,
the second circuit part further includes:
a second-fifth transistor configured to be turned on in response to the voltage of the Q node and transmits a voltage of a second B clock signal that is input to a third B clock node, to a third output node; and
a second-sixth transistor configured to be turned on in response to the voltage of the QB node and electrically connects the third output node to the VGL node,
wherein each of the second-fifth transistor and the second-sixth transistor of the second circuit part is a p-channel transistor,
a B clock signal that is input to the first B clock node is a signal with a phase opposite to a phase of a G clock signal that is input to the first G clock node, and
a B clock signal that is input to the third B clock node is a signal with a phase opposite to a phase of a G clock signal that is input to the second G clock node,
wherein, the second circuit part is configured to output the pulse of the second output signal via the second output node in synchronization with a pulse of the first B clock signal and then output a pulse of a third output signal via the third output node in synchronization with a pulse of the second B clock signal.

11. The gate driving circuit according to claim 4, wherein the first circuit part includes:
a first-first transistor including a gate electrode connected to a first G clock node, a first electrode connected to a VST node, and a second electrode connected to the Q2 node;
a first-second transistor including a gate electrode connected to the VST node, a first electrode connected to the first G clock node via a second capacitor, and a second electrode connected to a VGH node to which the first gate voltage is applied;
a first-third transistor including a gate electrode coupled to the first G clock node via the second capacitor, a first electrode connected to the first G clock node, and a second electrode connected to the QB node;
a first-fourth transistor including a gate electrode connected to the Q2 node, a first electrode connected to the QB node, and a second electrode connected to the VGH node;
a first-fifth transistor including a gate electrode connected to the VGL node, a first electrode connected to the Q1 node, and a second electrode connected to the Q2 node;
a first-sixth transistor including a gate electrode connected to the Q1 node, a first electrode connected to the VGL node, and a second electrode connected to a first output node from which the pulse of the first output signal is output; and
a first-seventh transistor including a gate electrode connected to the QB node, a first electrode connected to the first output node, and a second electrode connected to the VGH node.

12. The gate driving circuit according to claim 11, wherein a pulse interval of a G clock signal that is input to the first G clock node is greater than a pulse interval of a B clock signal that is input to each of the first B clock node and the second B clock node.

13. The gate driving circuit according to claim 11, wherein a pulse interval of the first output signal is greater than a pulse interval of the second output signal.

14. The gate driving circuit according to claim 5, wherein:
the second circuit part includes first and second buffers sharing the Q node and the QB node, wherein the first buffer including the second-third transistor and the second-fourth transistor, and the second buffer including the second-fifth transistor and the second-sixth transistor, and
the first-second transistor, the first-fourth transistor, and the first-eighth transistor configure an inverter circuit that charges and discharges the voltage of the QB node to a voltage with a phase opposite to the phase of the voltage of the Q node, the Q1 node, and the Q2 node.

15. A display device comprising:
a display panel in which a plurality of data lines, a plurality of gate lines, a plurality of pixels, and a gate driving circuit configured to output a gate signal to the plurality of gate lines are provided,
wherein each of the pixels includes a plurality of n-channel transistors that are switched in response to the gate signal,
the gate driving circuit includes:
a first circuit part that includes a Q1 node, a Q2 node, and a QB node and is configured to receive a G clock signal and a start signal or a carry signal and output a pulse of a first output signal via a first output node; and
a second circuit part that includes a Q node, is connected to the QB node, and is configured to receive at least one B clock signal and output a pulse of a second output signal,
wherein the G clock signal includes a pulse of a first gate voltage, and the B clock signal includes a pulse of a second gate voltage lower than the first gate voltage.

16. The display device according to claim 15, wherein the second circuit part includes:
a second-first transistor including a gate electrode connected to the Q node, a first electrode connected to a first B clock node, and a second electrode;
a second-second transistor including a gate electrode connected to a VGL node configured to receive the second gate voltage, a first electrode connected to the Q2 node, and a second electrode connected to the Q node;
a capacitor connected between the Q node and the second electrode of the second-first transistor;
a second-third transistor configured to be turned on in response to a voltage of the Q node and to transmit a voltage of a first B clock signal that is input to a second B clock node, to a second output node from which the pulse of the second output signal is output; and
a second-fourth transistor configured to be turned on in response to a voltage of the QB node and to electrically connect the second output node to the VGL node.

17. The display device according to claim 16, wherein a pulse of a fourth B clock signal that is input to the first B clock node is generated earlier than a pulse of the first B clock signal that is input to the second B clock node.

18. The display device according to claim 16, wherein:
the first circuit part includes a plurality of p-channel transistors, and
each of the second-first transistor, the second-second transistor, the second-third transistor, and the second-fourth transistor of the second circuit part is a p-channel transistor.

19. The display device according to claim 18, wherein,
the second circuit part further includes:
a second-fifth transistor configured to be turned on in response to the voltage of the Q node and to transmit a voltage of a second B clock signal that is input to a third B clock node, to a third output node; and
a second-sixth transistor configured to be turned on in response to the voltage of the QB node and to electrically connect the third output node to the VGL node, and
each of the second-fifth transistor and the second-sixth transistor of the second circuit part is a p-channel transistor,
wherein the second circuit part is configured to output the pulse of the second output signal via the second output node in synchronization with a pulse of the first B clock signal and then output a pulse of a third output signal via the third output node in synchronization with a pulse of the second B clock signal.

20. The display device according to claim 18, wherein the first circuit part includes a shift register including the plurality of p-channel transistors or an edge trigger including the plurality of p-channel transistors.
